(19) United States
(12) Patent Application Publication
(10) Pub. No.: US 2025/0194885 A1
(43) Pub. Date: Jun. 19, 2025

(54) CLEANING ROBOTS, CONTROL METHOD AND CONTROL APPARATUS, AND STORAGE MEDIUM

(71) Applicant: Qfeeltech (Beijing) Co., Ltd., Beijing (CN)

(72) Inventors: Xin WU, Beijing (CN); Huizhong AN, Beijing (CN); Junyi SHA, Beijing (CN)

(21) Appl. No.: 19/071,733

(22) Filed: Mar. 5, 2025

Related U.S. Application Data
(63) Continuation of application No. PCT/CN2023/108420, filed on Jul. 20, 2023.

(30) Foreign Application Priority Data
Sep. 6, 2022 (CN) 202211082403.6

(51) Int. Cl. A47L 11/40; A47L 1/02; G05D 1/648; G05D 1/661; G05D 105/10

(52) U.S. Cl. CPC A47L 11/4011; A47L 1/02; G05D 1/648; G05D 1/661; G05D 2105/10

(57) ABSTRACT

The present disclosure relates to a cleaning robot, a control method and control apparatus, and a storage medium. The control method includes receiving a weekly cleaning constraining condition input by a user, the weekly cleaning constraining condition representing a condition to be satisfied when the cleaning robot cleans, in a pre-set period, one or more sub-zones of a plurality of sub-zones corresponding to a work zone included in a map of the work zone. The control method also includes determining a plurality of weekly plan options that satisfy the weekly cleaning constraining condition. The control method also includes providing the plurality of weekly plan options to the user, and obtaining a to-be-executed weekly plan option selected by the user from the plurality of weekly plan options. The control method further includes controlling the cleaning robot to execute cleaning tasks in the pre-set period based on the to-be-executed weekly plan option.

### CROSS REFERENCE TO RELATED APPLICATIONS

This application is a continuation of International Application No. PCT/CN2023/108420, filed on Jul. 20, 2023, which claims priority to Chinese Patent Application No. 202211082403.6, filed on Sep. 6, 2022, titled “CLEANING ROBOT AND CONTROL METHOD AND CONTROL APPARATUS, USER DEVICE AND STORAGE MEDIUM.” The contents of the above-referenced applications are incorporated herein by reference in their entirety.

### TECHNICAL FIELD

The present disclosure relates to the field of smart home technology, and in particular, to a cleaning robot, its control method and control apparatus, a user device and a storage medium.

### BACKGROUND TECHNOLOGY

In existing technology, in a process when a cleaning robot cleans a room, by default, the cleaning robot is configured to clean an entire area-to-be-cleaned of a closed space (e.g., an entire to-be-cleaned floor of the closed space). Even with some cleaning robots that are claimed to be equipped with smart technical solutions, such smart technical solutions merely involve having the cleaning robots to ask the user to select an unambiguous time, a specific zone, and a determined work mode for performing a cleaning task.

However, the users' cleaning needs may differ for different people, at different time. If a cleaning robot performs a cleaning task based on a fixed cleaning plan, it is possible that a user's personalized cleaning needs may not be satisfied. In addition, some users do not like and are unwilling to make tedious settings for options. This also makes the existing cleaning robots appear to be not so intelligent. On one hand, it increases the time spent by the users on customizing the settings. On the other hand, it degrades user experience.

Therefore, one of the issues to be addressed for making the existing cleaning robots more intelligent is how to provide a simple, customizable cleaning services to a user in response to the user's personalized cleaning needs.

### SUMMARY OF DISCLOSURE

In light of the above issues, the present disclosure provides a cleaning robot, a cleaning method and a control apparatus for the cleaning robot, a user device, and a storage medium.

According to a first aspect of the present disclosure, a control method for a cleaning robot is includes: receiving a weekly cleaning constraining condition input by a user, where the weekly cleaning constraining condition represents a condition to be satisfied when the cleaning robot cleans, in a pre-set period, one or more sub-zones of a plurality of sub-zones corresponding to a work zone included in a map of the work zone, where the pre-set period is a period that uses day as a unit and includes a pre-set number of days, and where the pre-set number of days is greater than a number of days included in a daily cleaning period, and is less than a number of days included in a monthly cleaning period; determining a plurality of weekly plan options that satisfy the weekly cleaning constraining condition; providing the plurality of weekly plan options to the user; obtaining a to-be-executed weekly plan option selected by the user from the plurality of weekly plan options; and controlling the cleaning robot to execute a cleaning task according to the to-be-executed weekly plan option in the pre-set period.

According to a second aspect of the present disclosure, a control apparatus (or control device) for a cleaning robot includes: a receiving unit configured to receive a weekly cleaning constraining condition input by a user, where the weekly cleaning constraining condition represents a condition to be satisfied when the cleaning robot cleans, in a pre-set period, one or more sub-zones of a plurality of sub-zones corresponding to a work zone included in a map of the work zone, where the pre-set period is a period that uses day as a unit and includes a pre-set number of days, and where the pre-set number of days is greater than a number of days included in a daily cleaning period, and less than a number of days included in a monthly cleaning period; a determining unit configured to determine a plurality of weekly plan options that satisfy the weekly cleaning constraining condition; a rendering unit configured to provide the plurality of weekly plan options to the user; an obtaining unit configured to obtain a to-be-executed weekly plan option selected by the user from the weekly plan options; and a control unit configured to control the cleaning robot to execute a cleaning task according to the to-be-executed weekly plan option in the pre-set period.

According to a third aspect of the present disclosure, a control apparatus for a cleaning robot includes: one or more processors; and a storage device, which stores instructions, which when executed by the one or more processors, cause the one or more processors to execute the above-described control method.

According to a fourth aspect of the present disclosure, a user device is provided, which includes the above-described control apparatus.

According to a fifth aspect of the present disclosure, a cleaning robot is provided, which includes the above-described control apparatus.

According to a sixth aspect of the present disclosure, a non-transitory computer-readable storage medium is provided. The computer-readable storage medium stores computer-executable instructions. When the instructions stored in the storage medium are executed by a processor, the instructions cause the processor to execute the above-described control method. The non-transitory computer-readable medium may be any suitable storage medium, such as a read-only memory, a random-access memory, a flash memory, a hard disk, an optic disk, a secure digital card, a solid state disk, etc. The processor may be any suitable processor, such as a central processing unit, a graphic processing unit, an application specific integrated circuit, etc. The processor may be a processor of a cleaning robot or a processor of a user device or a controller configured to receive user input and provide instructions or signals to the cleaning robot for controlling the operations of the cleaning robot, or a processor of a remote server that may be connected with the cleaning robot through a network and that may be configured to provide instructions or signals to control the operations of the cleaning robot.

According to the present disclosure, as compared to traditional, fixed and rigid cleaning plans, in which the user directly inputs when and which zones the cleaning tasks are to be performed, the technical solutions of the present disclosure merely need to provide a few questions to a user about the user's life habits and preferences. Based on the user input, in the present disclosure, a series of weekly plan options that satisfy the user's habits and preferences are computed and provided to the user. Thus, a cleaning robot of the present disclosure can execute the cleaning tasks in a more intelligent and personalized manner, thereby enhancing the user experience. In addition, compared to daily cleaning and monthly cleaning, the present disclosure uses weekly cleaning, which better fits the habits and paces of routine life and work of ordinary people. Therefore, the cleaning robot of the present disclosure can execute cleaning tasks in a manner that better fits the life and work habits of the users.

Based on the following detailed descriptions of the illustrative embodiments with reference to the accompanying drawings, other features and aspects of the present disclosure will become clearer.

### BRIEF DESCRIPTIONS OF DRAWINGS

The drawings included in the specification and forming a part of the specification, together with the specification, show illustrative embodiments, features, and aspects of the present disclosure, and are used to explain the principles of the present disclosure.

FIG. 1a is a flowchart showing a control method for a cleaning robot according to an illustrative embodiment of the present disclosure.

FIGS. 1b-1c show maps of a closed space according to an illustrative embodiment of the present disclosure.

FIG. 2a is a flowchart showing a control method for a cleaning robot according to an illustrative embodiment of the present disclosure.

FIG. 2b is a schematic illustration of setting a key zone according to an illustrative embodiment of the present disclosure.

FIG. 2c is a schematic illustration of setting a first condition according to an illustrative embodiment of the present disclosure.

FIG. 2d is a schematic illustration of setting a do-not-disturb time segment according to an illustrative embodiment of the present disclosure.

FIG. 3 is a flowchart showing a control method for a cleaning robot according to an illustrative embodiment of the present disclosure.

FIG. 4 is a flowchart showing a control method for a cleaning robot according to an illustrative embodiment of the present disclosure.

FIG. 5 is a flowchart of a control method for a cleaning robot according to an illustrative embodiment of the present disclosure.

FIG. 6 is a flowchart showing a control method for a cleaning robot according to an illustrative embodiment of the present disclosure.

FIG. 7a is a flowchart of a control method for a cleaning robot according to an illustrative embodiment of the present disclosure.

FIG. 7b is a schematic illustration of a cleaning report according to an illustrative embodiment of the present disclosure.

FIG. 8 is a flowchart showing a control method for a cleaning robot according to an illustrative embodiment of the present disclosure.

FIG. 9 is a schematic diagram of a control apparatus for a cleaning robot according to an illustrative embodiment of the present disclosure.

### DETAILED DESCRIPTIONS

Next, various illustrative embodiments, features, and aspects of the present disclosure will be explained in detail with reference to the accompanying drawings. The same labels in the accompanying drawings represent components having the same or similar functions. Although various aspects are illustrated in the accompanying drawings, unless otherwise noted, the drawings are not necessarily to scale.

The specific term “illustrative” as used herein means “as an example, an embodiment, or illustration.” Any embodiment modified by the term “illustrative” need not be interpreted as being advantageous or better than other embodiments.

In addition, to better explain the present disclosure, various specific details are provided in the following detailed implementations. A person having ordinary skills in the art can appreciate that without certain specific details, the present disclosure can still be implemented. In some other embodiments, methods, means, components and electric circuits that may be well-known to a person having ordinary skills in the art are not explained in detail, such that the main principle of the present disclosure can be conveniently explained.

As described above, if a cleaning robot executes or performs cleaning tasks based on a fixed and rigid cleaning plan, a user's personalized cleaning need is often not satisfied; on the other hand, if a user is requested to select the unambiguous time, the specific zone, and the determined work mode for executing the cleaning task, it makes the cleaning robot appear not as intelligent as people expect. On one hand, it increases the time spent by the user on configuring customized settings, on the other hand, it degrades the user experience.

In addition, in existing technology, a cleaning plan of a cleaning robot is typically configured using day as a unit; however, people's routine work and life are often arranged using week (e.g., a week is seven days) as a unit. Therefore, for users of cleaning robots, using week as a unit to configure the cleaning settings of the cleaning robots for executing cleaning tasks better fit people's habits. For example, some users prefer to having the cleaning robot execute cleaning tasks on weekdays from Monday to Friday when the users are not at home, and having the cleaning robot not operate on weekends from Saturday to Sunday such that the cleaning robot does not disrupt the users from having a break. As such, the cleaning plan determined in the present disclosure is a weekly plan, i.e., the cleaning plan uses week as a unit, which better fits people's work and life habits.

Furthermore, because a user may have personalized need for his/her life, and may not be willing to repeatedly provide clear, definite and yet tedious execution instructions to the cleaning robot, and may only be willing to or able to provide some ambiguous, limiting constraining conditions. Examples of the ambiguous, limiting constraining conditions may include: performing more cleanings to some key zones and less cleanings to some non-key zones such that the total cleaning time is shortened, or not performing cleaning in certain time segments, etc. Therefore, in the present disclosure, a constraining condition based on a user's cleaning demands or wishes may be used as an input. Through fast computing speed and strong computing power of modern processors or computing chips, a plurality of weekly plan options that satisfy the above constraining condition (also referred to as weekly cleaning constraining condition in the present disclosure) and that can be unambiguously executed by the cleaning robot may be provided to the user. A user selection of an option from the plurality of weekly plan options that satisfy the user's personalized need may be used as a to-be-executed weekly plan option, which is to be executed by the cleaning robot. Finally, the cleaning robot may execute cleaning tasks based on the to-be-executed weekly plan option selected by the user. As such, the cleaning robot can provide customized and personalized cleaning services to the user in a more intelligent manner, thereby enhancing the user experience.

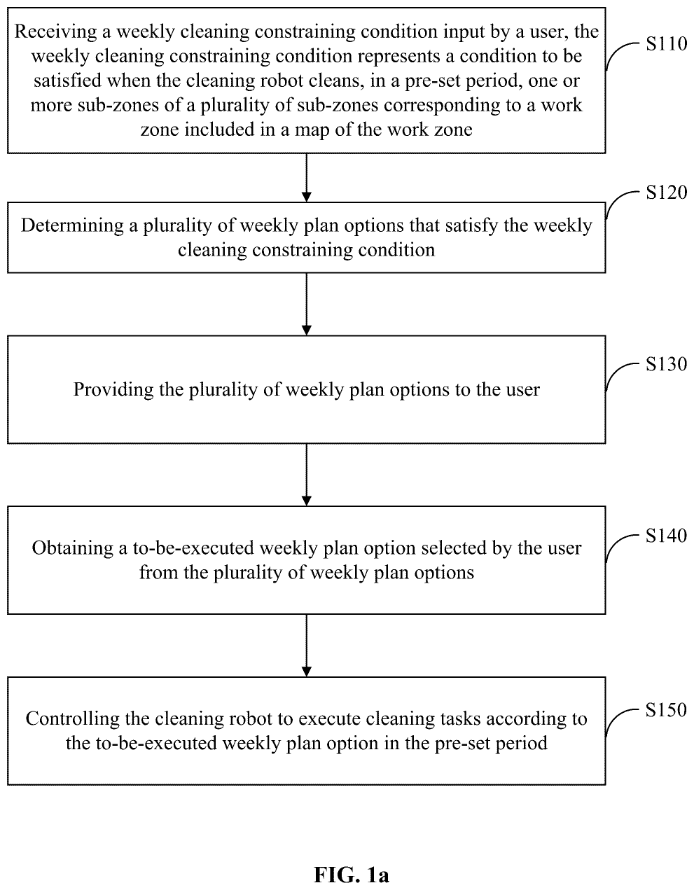

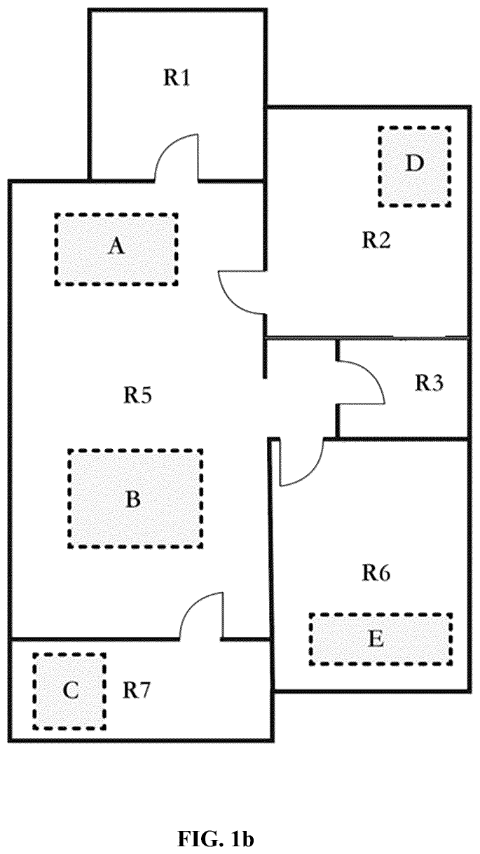

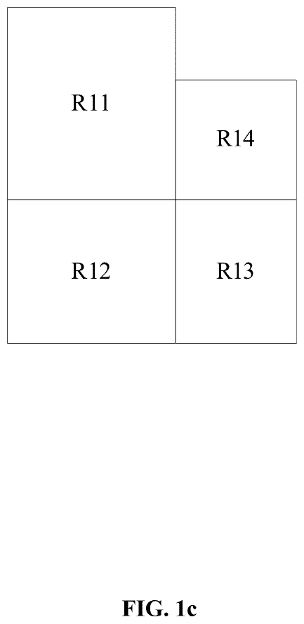

Based on the above conception, FIG. 1a shows a control method for a cleaning robot according to an illustrative embodiment. The execution body of the control method of the present embodiment may be, but not be limited to, a cleaning robot, devices (such as user devices) such as a server, a processor, or a computing device that may be connected to the cleaning robot through a network. Illustratively, in below descriptions, the control method of the present embodiment is described as being executed by a processor of a cleaning robot or a user device.

A cleaning robot may be, for example, a device configured to autonomously move in a space of an actual work zone to clean trash (e.g., dust, dirty water, etc.) on a floor, thereby autonomously cleaning the space. Here, the space of the actual work zone of the cleaning robot may be a closed space formed by multiple rooms, or may be an open space such as an outdoor space. In other words, the cleaning robot may be configured to clean an indoor space of a certain home that is to be cleaned. Additionally and/or alternatively, the cleaning robot may be configured to clean a floor of a to-be-cleaned outdoor space such as a plaza or a courtyard.

Here, the cleaning robot may include, but not be limited to, for example, a smart floor sweeping robot, a smart floor mopping robot, a sweeping-mopping integrated robot, and a window cleaning robot, etc. A user device may include, but not be limited to, for example, a device that can establish a communication connection with the cleaning robot and has a display interface, such as a mobile terminal device (e.g., a cell phone, a pad, etc.), or terminal devices such as a server, a desktop computer, etc. The user device may also be referred to as an APP end device of the cleaning robot.

### First Embodiment

Referring to FIG. 1a, a control method of this illustrative embodiment may include the following steps:

Step S110, receiving a weekly cleaning constraining condition input by a user, where the weekly cleaning constraining condition represents a condition to be satisfied when the cleaning robot performs cleaning, in a pre-set period (e.g., in a week), one or more sub-zones of a plurality of sub-zones corresponding to a work zone included in a map of the work zone.

In this embodiment, the following situations are taken into consideration: the user may have personalized need for his/her arrangement of work and life and he/she typically arranges the work and life and executes cleaning tasks based on a unit of week, and may typically not be willing to or not good at providing clear, definite yet tedious instructions to a cleaning robot, and may only be willing to provide relatively ambiguous (relative to instructions) weekly cleaning constraining condition that serves a limiting function, such as limiting conditions on parameters such as a number of cleanings, a cleaning time, a cleaning area, etc. For example, the user may wish that the cleaning robot operates 5 times each week, the user may wish that the cleaning robot perform more cleanings to the dining area, the user may wish that the cleaning robot does not operate when the user is taking a break, the user may wish that the cleaning robot cleans the bedroom at least twice a week, and so on.

The user may input the weekly cleaning constraining condition on the user device based on his/her own cleaning needs. Illustratively, the user device may display questions, on its display interface, to the user for the user to input the weekly cleaning constraining condition (e.g., a form similar to a survey form), thereby obtaining the weekly cleaning constraining condition based on the user input of his/her own preferences and cleaning needs. A weekly cleaning constraining condition is a constraining condition to be satisfied when the cleaning robot cleans one or more sub-zones according to a week-based period. Week-based (or weekly) cleaning period (i.e., a pre-set period) is a period that uses day as a unit and includes a pre-set number of days (typically a week is counted as seven days for computation purposes). Here, the number of days included in a period based on weekly cleaning is greater than a number of days of a period based on daily cleaning and smaller than a number of days of a period based on monthly cleaning. The number of days included in a period based on daily cleaning is 1 day, the number of days included in a period based on monthly cleaning is 30, 31, or 28 days. In contrast, the number of days included in a period based on weekly cleaning includes, but is not limited to, 7 days (i.e., a week). Because most people arrange work and life based on 7 days a week, compared to daily cleaning and monthly cleaning, weekly cleaning better fits the work and life habits of a user of a cleaning robot. Therefore, it is more convenient to set a work plan for the cleaning robot based on week. In some embodiments, a period based on weekly cleaning may not have 7 days. For example, due to adjustment caused by Chinese traditional holidays such as Mid-Autumn Festival, National Day, Spring Festival, etc., a few adjacent weeks may be temporarily adjusted to not have 7 days.

Here, the actual work zone of the cleaning robot may be divided into a plurality of sub-zones. For example, when a space of the actual work zone of the cleaning robot is a closed space formed by a plurality of rooms, each of the plurality of rooms may be a sub-zone. For example, if the space of the actual work zone of the cleaning robot is an open space such as an outdoor space, a partial zone of the actual work zone may be a sub-zone. For the convenience of understanding, in the following descriptions, a closed space is used as an example to describe the sub-zones corresponding to the work zone.

Because it is needed to ensure that the cleaning robot does not move outside of the home of the user, the user typically closes a room door that connects the indoor space and the outdoor space, thereby forming a closed work zone, i.e., the above-described closed space. The closed space is not limited to the entire indoor space of the user, and may alternatively be a partial zone formed by a plurality of adjacent complete rooms in the entire indoor space. For example, the user may close some room doors in the home to separate these rooms from the entire indoor space. The remaining space is still a closed space, which may be a to-be-cleaned zone of the cleaning robot (this type of to-be-cleaned zone is typically a zone separated from the entire indoor space by room-dividing “boundaries” such as a wall and the closed room doors, and hence, this to-be-cleaned zone is a closed space formed by a plurality of complete rooms).

In some embodiments, the user device may obtain a map of the closed space from the cleaning robot, and may display the map to the user. Therefore, the user may set, through the user device, the weekly cleaning constraining condition that is related to the map of the closed space.

The cleaning robot may have previously cleaned a certain closed space, and may have established and stored, during the cleaning process, a map of the closed space (for example, the map of the closed space may have been stored in a storage unit of the cleaning robot (such as an internal storage device or element)). As such, when the cleaning robot performs cleaning tasks to the same closed space, the cleaning robot may directly obtain a map of the closed space from its storage unit. When the user device executes the control method of this illustrative embodiment, the user device may transmit an acquisition request to the cleaning robot for obtaining the map of the closed space. In response to the acquisition request, the cleaning robot may transmit the map of the closed space to the user device, or the cleaning robot may transmit/update the map of the closed space toward the user device periodically according to a pre-set time.

It should be understood that the cleaning robot may establish the map of the closed space using a relevant suitable method from existing technologies. For example, the cleaning robot may perform real time localization and mapping using cameras or light detection and ranging devices (Lidar devices) and through vision simultaneous localization and mapping (vSLAM) or laser SLAM, etc. Due to the limitation of space, detailed descriptions of the method used by the cleaning robot to establish the map of the closed space in this embodiment are not provided.

In some embodiments, the user device may directly obtain a previously stored map of the closed space from its storage unit (e.g., an internal storage device or element), and may display the map to the user. As such, the user may set, through the user device, the weekly cleaning constraining condition that is related to the map of the closed space.

The cleaning robot may establish a communication connection (wired or wireless connection) with the user device. When the cleaning robot performs cleaning or other work tasks in the closed space (e.g., zone covering tasks such as patrolling, logistic moving, following, etc.), the cleaning robot may transmit the map of the closed space that was established in previous work process to the user device through the communication connection between the cleaning robot and the user device. The user device may store the map in its storage unit. As such, when the user device executes the control method of this illustrative embodiment, the user device may directly obtain the map of the closed space from its storage unit.

In this embodiment, the map of the closed space corresponds to a plurality of rooms in a work zone. It should be understood that each room in the work zone may be formed by a room door and a wall, and the room door and the wall function as zone boundaries of this room to separate this room from other rooms. Therefore, each room is a smallest natural unit for forming the work zone. In other words, a work zone is formed by rooms. Here, adjacent rooms refer to at least two rooms that share at least a portion of the wall and/or room door. Interconnected two adjacent rooms means that the two adjacent rooms are connected at certain time through a floor channel that is configured for the cleaning robot to travel through (e.g., the room door between two adjacent rooms, a low and floor-touching pet door that is configured for a pet and a cleaning robot to travel through, a counter or furniture that has a hollow lower portion for short objects such as cleaning robots to travel through, etc.).

Referring to FIG. 1b, the map of the closed space may include a total of 6 rooms including rooms R1, R2, R3, R5, R6 and R7. The sector shape in the figure represents a room door that connects the two adjacent rooms. Referring to FIG. 1c, the map of the closed space includes 4 rooms R11-R14. For simplicity, FIG. 1c does not show the door room configured for connecting the adjacent rooms.

In this embodiment, a sub-zone of the closed space may be a corresponding sub-zone of a certain room. In some embodiments, a certain room may include one sub-zone, and this one sub-zone may include all zones of this room. Alternatively, this one sub-zone may be a partial zone in the room. In some embodiments, a certain room may include a plurality of sub-zones. Each of the plurality of sub-zones may be a partial zone in the room. The plurality of sub-zones may not overlap, therefore, repeated cleanings of sub-zones by the cleaning robot based on the map may be avoided.

Referring to FIG. 1b, the closed space may include a sub-zone A and a sub-zone B located in the room R5, a sub-zone C located in the room R7, a sub-zone D located in the room R2 and a sub-zone E located in the room R6. Each of the rooms R1 and R3 is one sub-zone. Therefore, each of rooms R1-R3 and R6-R7 includes one sub-zone. The room R5 includes two sub-zones.

After receiving the weekly cleaning constraining condition, step S120 may be executed.

Step S120, determining a plurality of weekly plan options that satisfy the weekly cleaning constraining condition.

Step S130, providing the plurality of weekly plan options to the user.

In this embodiment, the user device may use the weekly cleaning constraining condition provided based on the cleaning need of the user as an input. Through the strong computing power and fast computing speed of a processing unit of the cleaning robot or the user device, the weekly plan options that satisfy the weekly cleaning constraining condition and that can be executed by the cleaning robot may be generated based on the weekly cleaning constraining condition within a short period of time. The weekly plan options may be provided (e.g., displayed) to the user, such that the user may select an option that satisfies the personal needs of the user as a to-be-executed weekly plan option from the plurality of weekly plan options. Here, at least one weekly plan option may be generated. In some embodiments, when a plurality of weekly plan options are generated, and when the plurality of weekly plan options are displayed to the user, the plurality of weekly plan options may be sorted based on factors such as the cleaning preferences of the user, the life and work habits of the user, etc., and the plurality of weekly plan options may be displayed in the sorted order.

Step S140, obtaining a to-be-executed weekly plan option selected by the user from the plurality of weekly plan options.

Step S150, controlling the cleaning robot to execute cleaning tasks according to the to-be-executed weekly plan option in the pre-set period.

In this embodiment, the user may select the to-be-executed weekly plan option that satisfies preferences of the user from the plurality of weekly plan options provided on the user device. In response to the user selection, the user device may obtain the selected to-be-executed weekly plan option, and control the cleaning robot to execute cleaning tasks according to the to-be-executed weekly plan option in the pre-set period.

It can be understood that the computing principle of the processing unit of the user device typically involves using an exhaustive search method to check whether each weekly plan option satisfies the weekly cleaning constraining condition input by the user. In addition, because the computing speed of the computer (or the processing unit) is very fast, the computer can filter a large number of weekly plan options using the weekly cleaning constraining condition in a short period of time, and provide weekly plan options that satisfy the weekly cleaning constraining condition to the user, such that the user may select a to-be-executed weekly plan option that satisfies the preferences (i.e., cleaning needs) of the user. This method replaces the traditional method in which the user directly inputs unambiguous but tedious control instructions on the user device, and then the cleaning robot executes the to-be-executed weekly plan option selected by the user.

After the user selects an option that satisfies the personalized needs of the user as the to-be-executed weekly plan option, the cleaning robot may execute cleaning tasks according to the to-be-executed weekly plan option selected by the user. For example, based on the to-be-executed weekly plan option, it may be determined, for example, which sub-zone (or sub-zones) needs to be cleaned on each day of the pre-set period and how many times each sub-zone needs to be cleaned, or even within what time period the cleaning task needs to be performed, etc., and then the cleaning task may be executed. As such, the cleaning tasks may be performed based on user's needs.

Therefore, according to this embodiment, the interface of the user device or the cleaning robot may display questions configured for the user to input the weekly cleaning constraining condition (e.g., a form similar to a survey form), thereby obtaining the weekly cleaning constraining condition input by the user based on the preferences and cleaning needs of the user. Then, the processing unit of the user device or the cleaning robot may perform computation and provide a plurality of weekly plan options that satisfy the weekly cleaning constraining condition to the user, and obtain the to-be-executed weekly plan option that the user selects from the plurality of weekly plan options. Finally, the cleaning robot may execute the cleaning tasks according to the to-be-executed weekly plan option in the pre-set period. As such, as compared to traditional, fixed and rigid cleaning plans, in which the user directly inputs when and which zones the cleaning tasks are to be performed, the present embodiment merely need to provide to the user a few questions about the life habits and preferences of the user, and then performs computation based on the user's answers to the questions, and automatically provides to the user a series of weekly plan options that satisfy the habits and preferences of the user. The present embodiment enables the cleaning robot to be able to perform cleaning tasks in a more intelligent and personalized manner, thereby enhancing the user experience. In addition, compared to daily cleaning and monthly cleaning, the weekly cleaning performed by the cleaning robot in the present embodiment better fits the daily life and work habits and paces of ordinary people, and therefore, the cleaning robot of the present embodiment can execute cleaning tasks that better fit the daily life and work habits of the user.

In some embodiments, the weekly plan options may change as the weekly cleaning constraining condition changes. Once the to-be-executed weekly plan option changes, the cleaning robot may be controlled to execute new cleaning tasks according to the changed to-be-executed weekly plan option in the pre-set period.

In this embodiment, because the weekly plan option needs to satisfy the weekly cleaning constraining condition, once the weekly cleaning constraining condition changes, the weekly plan options also change, and the to-be-executed weekly plan option selected from the weekly plan options also changes. Correspondingly, the cleaning robot may be controlled to execute new cleaning tasks according to the changed to-be-executed weekly plan option in the pre-set period.

Therefore, compared to traditional cleaning plans in which once the cleaning task is determined, the cleaning task cannot be changed, in the present embodiment, the cleaning tasks performed by the cleaning robot may change as the weekly cleaning constraining condition changes, which enables the cleaning robot to better adapt to new cleaning needs of the user, thereby enhancing the user experience.

In some embodiments, the pre-set period may be an integer multiple of a week. In other words, the pre-set period may be one week, or may be two or more multiples of one week.

In some embodiments, the pre-set period may be seven days of a typically understood week. In this situation, the pre-set period may include 7 days. For example, the pre-set period may be 7 days from Sunday to next Saturday, or 7 days from Monday to Sunday, or 7 days from Tuesday to next Monday, or 7 days from Wednesday to next Tuesday, and so on. In some embodiments, the pre-set period may be at least 2 days but less than 7 days. In such a situation, the pre-set period may include 2 days, 3 days, 4 days, 5 days or 6 days. For example, the pre-set period may be 4 days from Monday to Thursday, or 5 days from Tuesday to Saturday, or 3 days from Wednesday to Friday, etc. In such a situation, at other time of a week that is outside of the pre-set period, the cleaning tasks may be configured using other methods. For example, when the pre-set period is 5 days from Monday to Friday, then the cleaning tasks may be configured using the method of the present disclosure only in the 5 days of the pre-set period, and for Saturday and Sunday that are outside of the pre-set period, the cleaning tasks may be configured using other methods or the cleaning tasks are not configured.

On the basis of the first embodiment, further limiting the received weekly cleaning constraining condition to include a first condition and/or a second condition yields a second embodiment.

### Second Embodiment

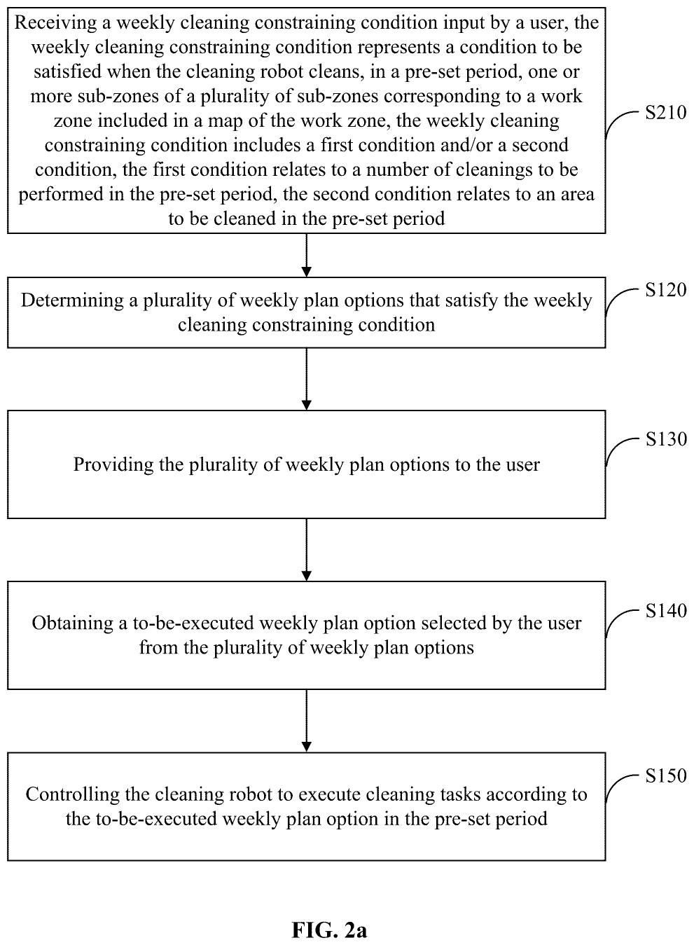

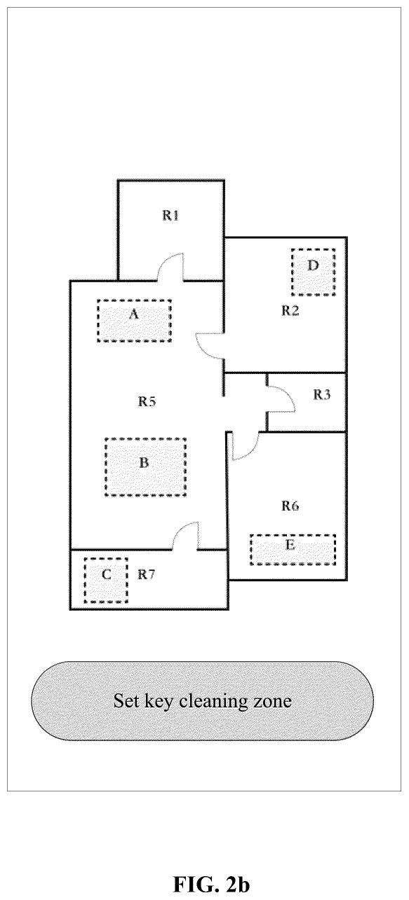

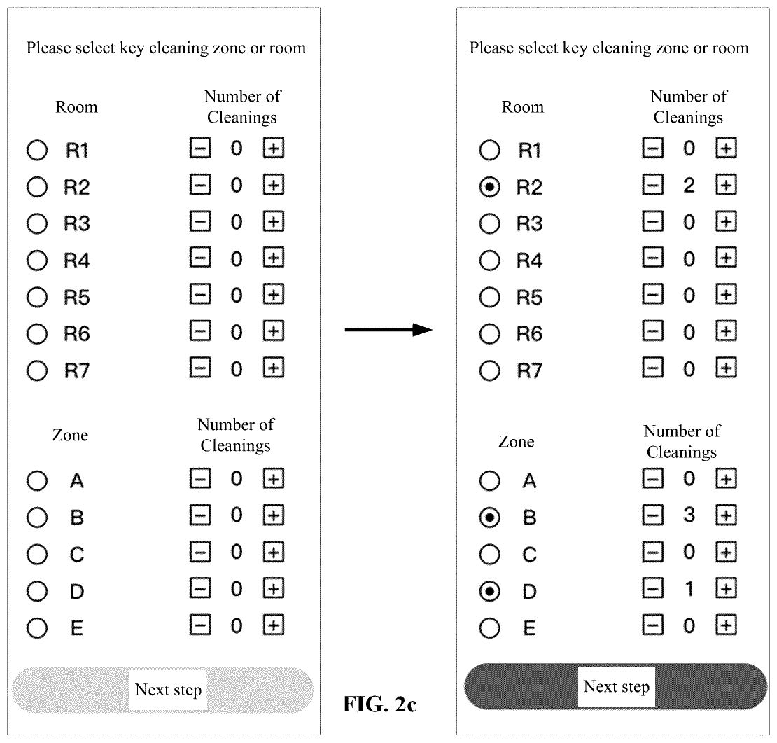

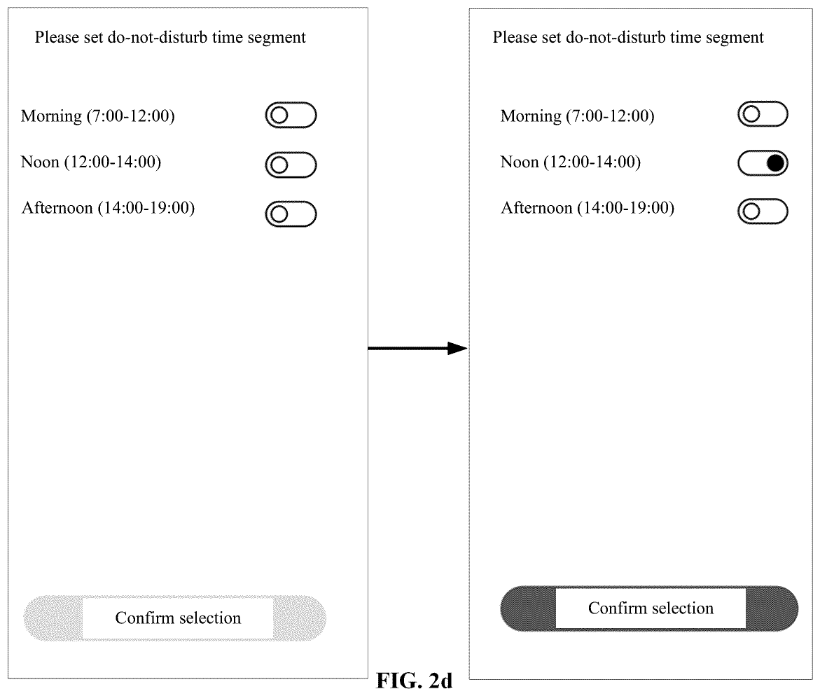

Referring to FIG. 2, the control method of this illustrative embodiment may include the following steps:

Step S210, receiving weekly cleaning constraining condition input by the user, where the weekly cleaning constraining condition represents a condition to be satisfied when the cleaning robot cleans, in a pre-set period, one or more sub-zones of a plurality of sub-zones corresponding to a work zone included in a map of the work zone. The weekly cleaning constraining condition may include a first condition and/or a second condition. The first condition may relate to a number of cleanings to be performed in the pre-set period. The second condition may relate to an area to be cleaned in the pre-set period.

In this embodiment, the weekly cleaning constraining condition may include a limiting condition based on the number of cleanings (i.e., the first condition) and/or a limiting condition based on the cleaning area (i.e., the second condition). The first constraining condition may be configured to specify the number of cleanings and the second constraining condition may be configured to specify the cleaning area (i.e., area to be cleaned). It should be understood that the weekly cleaning constraining condition may include any combination of the first condition and the second condition, for example, one first condition, multiple first conditions, one second condition, multiple second conditions, one first condition and one second condition, one first condition and multiple second conditions, multiple first conditions and one second condition, or multiple first conditions and multiple second conditions.

Illustratively, if the first condition specifies a first pre-set number of cleanings, and the second condition specifies a first cleaning area, then the two conditions may together form a first weekly cleaning constraining condition. If the first condition includes a condition that specifies a first pre-set number of cleanings and a condition that specifies a second pre-set number of cleanings (i.e., there are two first conditions), and the second condition includes a condition that specifies a first cleaning area and a condition that specifies a second cleaning area (i.e., there are two second conditions), then the two first conditions and the two second conditions may together form a weekly cleaning constraining condition.

In some embodiments, the plurality of sub-zones may be divided into a plurality of categories. The first condition may be configured to specify a total number of cleanings to be performed in the pre-set period for a corresponding category of sub-zones and/or to specify a number of cleanings to be performed on each day of the pre-set period for a corresponding category of sub-zones.

In this embodiment, multiple sub-zones may be divided into multiple categories. In some embodiments, the multiple sub-zones may be divided based on the cleaning needs of the sub-zones. In some embodiments, the multiple sub-zones may be divided based on categories of the sub-zones set by the user. Correspondingly, the sub-zones of various categories set by the user may be obtained. Illustratively, referring to FIG. 2b, the user may set key zones A, B, C, D, and E. Alternatively, the multiple sub-zones may be divided using any suitable dividing algorithm of the existing technologies, which are not described due to the limitation of space.

In some embodiments, the multiple sub-zones may be divided into a first category of sub-zones and a second category of sub-zones. The first category of sub-zones may be, for example, key zones (zones or rooms where heavy-duty cleaning is to be performed), and the second category of sub-zones may be, for example, non-key zones (zones or rooms where light-duty cleaning is to be performed). In such a situation, the first condition may be configured to specify a total number of cleanings to be performed in the pre-set period for at least one of the first category of sub-zones or the second category of sub-zones, and/or to specify a number of cleanings to be performed on each day of the pre-set period for each category of the first category of sub-zones and the second category of the sub-zones. Illustratively, the first condition may specify that the first category of sub-zones are to be cleaned 7 times in every pre-set period, and the first category of sub-zones are to be cleaned 1 time on each day of every pre-set period.

In some embodiments, the multiple sub-zones may be divided into a first category of sub-zones, a second category of sub-zones, and a third category of sub-zones. The first category of sub-zones may be key zones (zones or rooms where heavy-duty cleaning is to be performed), the second category of sub-zones may be secondary key zones (zones or rooms where secondary heavy-duty cleaning is to be performed), the third category of sub-zones may be non-key zones (zones or rooms where light-duty cleaning is to be performed). In this situation, the first condition may be configured to specify a total number of cleanings to be performed in the pre-set period for at least one of the first to the third categories of sub-zones, and/or to specify a number of cleanings to be performed on each day of the pre-set period for at least one of the first to the third categories of sub-zones.

In some embodiments, the total number of cleanings to be performed in the pre-set period for a corresponding category of sub-zones may be, W=a sum of numbers of cleanings to be performed on each day of d days in the pre-set period when cleaning is needed for the corresponding category of sub-zones. In some embodiments, illustratively, when the number of cleanings to be performed on each day for the corresponding category of sub-zones is the same, then the total number of cleanings to be performed in the pre-set period for the corresponding category of sub-zones, W=(a number N of cleanings to be performed on each day of the pre-set period for the corresponding category of sub-zones)×(the number of days d in the pre-set period in which cleaning is needed for the corresponding category of sub-zones). For example, presuming that the first category of sub-zones are to be cleaned 7 days in the pre-set period and to be cleaned 1 time on each day, then the total number of cleanings to be performed in the pre-set period for the first category of sub-zones is W1=N×d=1×7=7 times.

In some embodiments, the first condition being configured to specify the total number of cleanings to be performed in the pre-set period for the corresponding category of sub-zones may include: the first condition being configured to specify that the total number of cleanings to be performed in the pre-set period for the corresponding category of sub-zones is greater than or equal to a first pre-set number, or, the first condition being configured to specify that the total number of cleanings to be performed in the pre-set period for the corresponding category of sub-zones is greater than or equal to an upper limit of a first pre-set number range. For example, the first condition may specify that the first category of sub-zones are to be cleaned at least 4 times in every pre-set period and that the second category of sub-zones are to be cleaned at least 1 time in every pre-set period. As another example, the first condition may specify that the number of cleanings for the first category of sub-zones in every pre-set period is greater than or equal to an upper limit of a pre-set number range of [2, 5], i.e., the first category of sub-zones are to be cleaned at least 5 times in every pre-set period.

In some embodiments, the first condition being configured to specify the total number of cleanings to be performed on each day of the pre-set period for the corresponding category of sub-zones may include: the first condition being configured to specify that the total number of cleanings to be performed on each day of the pre-set period for the corresponding category of sub-zones is greater than or equal to a second pre-set number, or being configured to specify that the total number of cleanings to be performed on each day of the pre-set period for the corresponding category of sub-zones is greater than or equal to an upper limit of a second pre-set number range. For example, the first condition may be configured to specify that the first category of sub-zones are to be cleaned at least 1 time on each day of every pre-set period. As another example, the first condition may be configured to specify that the total number of cleanings to be performed for the first category of sub-zones on each day of every pre-set period is greater than or equal to an upper limit of a pre-set number range of [1, 3], i.e., the first category of sub-zones are to be cleaned at least 3 times on each day of every pre-set period.

In some embodiments, the multiple categories may include at least a first category and a second category. The first category of sub-zones may be, for example, key zones (zones or rooms where heavy-duty cleaning is to be performed), and the second category of sub-zones may be non-key zones (zones or rooms where light-duty cleaning is to be performed). The first condition being configured to specify the total number of cleanings to be performed in the pre-set period for the corresponding category of sub-zones may include: the first condition being configured to specify total numbers of cleanings to be performed in the pre-set period for each of the first category of sub-zones and the second category of sub-zones. The first condition being configured to specify the number of cleanings to be performed on each day of the per-set period for the corresponding category of sub-zones may include: the first condition being configured to specify the number of cleanings to be performed on each day of the pre-set period for the first category of sub-zones. Here, the total number of cleanings to be performed for the first category of sub-zones in the pre-set period is greater than the total number of cleanings to be performed for the second category of sub-zones in the pre-set period. Illustratively, the first condition may specify that the first category of sub-zones are to be cleaned 7 times in every pre-set period, the first category of sub-zones are to be cleaned at least 1 time on each day of every pre-set period, and the second category of sub-zones are to be cleaned 4 times in every pre-set period.

In some embodiments, the multiple categories may include at least a first category, a second category, and a third category. Here, the first category of sub-zones are key zones (zones or rooms where heavy-duty cleaning is to be performed), the second category of sub-zones are secondary key zones (zones or rooms where secondary heavy-duty cleaning is to be performed), the third category of sub-zones are non-key zones (zones or rooms where light-duty cleaning is to be performed). The first condition being configured to specify the total number of cleanings to be performed in the pre-set period for the corresponding category of sub-zones may include: the first condition being configured to specify respective total numbers of cleanings to be performed in the pre-set period for each of the first categories of sub-zones, the second category of sub-zones, and the third category of sub-zones. Here, the total number of cleanings to be performed in the pre-set period for the first category of sub-zones is greater than the total number of cleanings to be performed in the pre-set period for the second category of sub-zones. The total number of cleanings to be performed in the pre-set period for the second category of sub-zones is greater than the total number of cleanings to be performed in the pre-set period for the third category of sub-zones. Illustratively, the first condition may be configured to specify that the first category of sub-zones are to be cleaned 7 times in every pre-set period, the second category of sub-zones are to be cleaned 4 times in every pre-set period, and the third category of sub-zones are to be cleaned 2 times in every pre-set period.

In some embodiments, the plurality of sub-zones may be divided into a plurality of categories. The second condition may be configured to specify a first area that is a sum of areas of sub-zones of all categories where cleaning is to be performed in the pre-set period and/or a second area that is a sum of areas of sub-zones of all categories where cleaning is to be performed on a single day. Here, the first area is equal to a sum of a plurality of products, where each product is a product of an area of each sub-zone in each category and a number of cleanings to be performed in the pre-set period corresponding to each sub-zone in each category. The second area is equal to a sum of a plurality of products, where each product is a product of an area of each sub-zone in each category where cleaning is to be performed on a single day and a number of cleanings to be performed on a single day for each corresponding sub-zone in each category.

In some embodiments, if the multiple categories include N categories, then the first area=(an area of the first category of sub-zones)×(a number of cleanings in the pre-set period for the first category of sub-zones)+(an area of the second category of sub-zones)×(a number of cleanings in the pre-set period for the second category of sub-zones)+ . . . +(an area of the N^{th} category of sub-zones)×(a number of cleanings in the pre-set period for the N^{th} category of sub-zones); the second area=(an area of the first category of sub-zones)×(a number of cleanings on a single day for the first category of sub-zones)+(an area of the second category of sub-zones)×(a number of cleanings on a single day for the second category of sub-zones)+ . . . +(an area of the N^{th} category of sub-zones)×(a number of cleanings on a single day for the N^{th} category of sub-zones). Correspondingly, the second condition may specify the first area and/or the second area calculated from the above-described formula. Illustratively, the second condition may specify that the first area of 100 m² is to be cleaned and the second area of 60 m² is to be cleaned.

In some embodiments, the second condition being configured to specify the first area may include: the second condition being configured to specify that the first area is smaller than or equal to a total area that can be cleaned in the pre-set period, or may be configured to specify that the first area is smaller than or equal to a lower limit of a total area range that can be cleaned in the pre-set period. The second condition being configured to specify the second area may include: the second condition being configured to specify that the second area is smaller than or equal to an area threshold, or being configured to specify that the second area is smaller than or equal to a lower limit of an area threshold range. For example, the second condition may specify that the first area is smaller than or equal to a total area of 110 m² that can be cleaned in the pre-set period, or the second condition may specify that the first area is smaller than or equal to a lower limit of a total area range of [115, 135]m² that can be cleaned in the pre-set period, i.e., the first area may be smaller than or equal to 115 m². As another example, the second condition may specify that the second area is smaller than or equal to an area threshold of 60 m², or the second condition may specify that the second area is smaller than or equal to a lower limit of an area threshold range of [65, 75]m², i.e., the second area may be smaller than or equal to 65 m².

In some embodiments, the sum of the cleaning areas that need to be completed (or covered) on a single day, i.e., the second area, is smaller than an area threshold or a lower limit of an area threshold range corresponding to a battery power threshold of the cleaning robot. As such, a situation can be avoided where the cleaning robot is unable to complete the cleaning tasks corresponding to the to-be-executed weekly plan option that corresponds to the second condition.

Step S120, determining a plurality of weekly plan options that satisfy the weekly cleaning constraining condition.

Illustratively, it is presumed that the pre-set period is from Monday to Sunday, the first category of sub-zones set by the user is a room R11, the second category of sub-zones includes rooms R12, R13, and R14, and the first condition set by the user specifies: in every pre-set period, the first category of sub-zones (i.e., room R11) are to be cleaned 7 times and to be cleaned 1 time on each day; in every pre-set period, the second category of sub-zones (i.e., rooms R12, R13, R14) are to be cleaned 1 time. The second condition set by the user specifies that the sum of cleaning areas that need to be completed on each day of the pre-set period, i.e., the second area, does not exceed 100 m². Moreover, it can be known from the operation of the cleaning robot: the cleaning area in room R11 (i.e., an area in which the cleaning robot can move and can perform cleaning tasks, which typically does not include floor areas occupied by floor obstacles such as walls, furniture, home appliances) is 50 m², the cleaning area in room R12 is 40 m², the cleaning area in room R13 is 30 m², the cleaning area in room R14 is 20 m². Based on the settings provided by the user and the actual situation of the work zone, the processing unit of the cleaning robot or the user device may filter out weekly plan options that satisfy the above conditions through a method that tries a large number of conditions or an exhaustive search method. Illustratively, as examples, the following weekly plan options may be determined:

| | | | | | | |
|---|---|---|---|---|---|---|
| Monday | Tuesday | Wednesday | Thursday | Friday | Saturday | Sunday |

Weekly Plan Option 1

| | | | | | | | |
|---|---|---|---|---|---|---|---|
| Zones | R11 + R12 | R11 + R13 | R11 + R14 | R11 | R11 | R11 | R11 |
| Number | 1 time for | 1 time | 1 time for | 1 time | 1 time | 1 time | 1 time |
| of | each | for each | each zone | | | | |
| Cleanings | zone | zone | | | | | |
| Area | 90 m² | 80 m² | 70 m² | 50 m² | 50 m² | 50 m² | 50 m² |

Weekly Plan Option 2

| | | | | | | | |
|---|---|---|---|---|---|---|---|
| Zones | R11 + R12 | R11 | R11 + R13 | R11 | R11 + R14 | R11 | R11 |
| Number | 1 time for | 1 time | 1 time for | 1 time | 1 time for | 1 time | 1 time |
| of | each zone | | each zone | | each zone | | |
| Cleanings | | | | | | | |
| Area | 90 m² | 50 m² | 80 m² | 50 m² | 70 m² | 50 m² | 50 m² |

Weekly Plan Option 3

| | | | | | | | |
|---|---|---|---|---|---|---|---|
| Zones | R11 | R11 + R13 | R11 + R14 | R11 + R12 | R11 | R11 | R11 |
| Number | 1 time | 1 time for | 1 time for | 1 time for | 1 time | 1 time | 1 time |
| of | | each | each zone | each | | | |
| Cleanings | | zone | | zone | | | |
| Area | 50 m² | 80 m² | 70 m² | 90 m² | 50 m² | 50 m² | 50 m² |

Weekly Plan Option 4

| | | | | | | | |
|---|---|---|---|---|---|---|---|
| Zones | R11 | R11 + R13 | R11 + R14 | R11 | R11 | R11 + R12 | R11 |
| Number | 1 time | 1 time for | 1 time for | 1 time | 1 time | 1 time for | 1 time |
| of | | each zone | each zone | | | each zone | |
| Cleanings | | | | | | | |
| Area | 50 m² | 80 m² | 70 m² | 50 m² | 50 m² | 90 m² | 50m2 |

As can be seen from above, the above options all satisfy the above-described user settings and the actual situation of the work zone. Therefore, these options can be the weekly plan options to be provided to the user for selection. Of course, it can be understood that, other weekly plan options that satisfy these conditions may be determined based on the first condition and the second condition. Not all weekly plan options that satisfy these conditions are listed exhaustively in the present embodiment due to the limitation of space.

Continuing with the above example, it is presumed that the user changes the second condition, such that the changed second condition specifies: (1) a sum of the cleaning areas that need to be completed on each day of the pre-set period, i.e., the second area, does not exceed 100 m²; (2) a cleaning area that needs to be completed on each day of Tuesday, Thursday, and Saturday does not exceed 60 m². Then after the processing unit performs computation and filtering on various scenarios, illustratively, only the weekly plan option 2 from the above multiple weekly plan options satisfies all of the weekly cleaning constraining conditions. As can be seen, by adjusting the number of weekly cleaning constraining conditions set by the users, the user can control the number of weekly plan options that the processing unit to eventually filters out that satisfy user's settings and the actual situation of the work zone.

Continuing with the above example, it is presumed that the user changes the second condition, such that the changed second condition specifies: (1) the sum of cleaning areas that need to be completed on each day of the pre-set period, i.e., the second area, does not exceed 100 m²; (2) the cleaning area that needs to be completed on each day of Tuesday, Wednesday, and Thursday is greater than 60 m². Then after the processing unit performs computation and filtering on various scenarios, illustratively, only the weekly plan option 3 in the above multiple weekly plan options satisfies all of the weekly cleaning constraining conditions.

Similarly, if the user sets the first condition in a more detailed and finer manner, the number of weekly plan options filtered out by the processing unit may be reduced. Examples are not provided due to the limitation of space.

Therefore, the more detailed the weekly cleaning constraining conditions input by the user are (i.e., the more limitations in the weekly cleaning constraining condition, especially the more limiting layers and perspectives, such as number of cleanings, area, order, time period, which all belong to different perspectives), then the relatively smaller the quantity of weekly plan options determined by the processing unit can be.

Step S130, providing the determined weekly plan options to the user.

Step S140, obtaining a to-be-executed weekly plan option selected by the user from the weekly plan options.

Step S150, controlling the cleaning robot to execute cleaning tasks in the pre-set period based on the to-be-executed weekly plan option.

Descriptions of the steps S130 to S150 can refer to those of the first embodiment, which are not repeated.

Therefore, according to the present embodiment, the first condition and/or the second condition input by the user based on the user's preferences and cleaning needs may be obtained. Then after the processing unit performs computation, a plurality of weekly plan options that satisfy the first condition and/or the second condition associated with the user settings and the actual situation of the work zone may be provided to the user, and a to-be-executed weekly plan option selected by the user from the plurality of weekly plan options may be obtained. Finally, the cleaning robot may execute cleaning tasks in the pre-set period according to the to-be-executed weekly plan option. As such, as compared to traditional, fixed and rigid cleaning plans, in which the user directly inputs when and which zones the cleaning tasks are to be performed, in the present embodiment, merely a few questions are provided to the user about the life habits and preferences of the user. Based on answers provided by the user, in the present embodiment, computation is performed and weekly plan options that satisfy the first condition and/or the second condition associated with the user settings and the actual situation of the work zone are automatically provided to the user. Accordingly, the present embodiment enables the cleaning robot to perform cleaning tasks in a more intelligent and personalized manner, thereby enhancing the user experience.

In some embodiments, a total area that can be cleaned in every pre-set period may be equal to a product of an area threshold corresponding to a battery power threshold of the cleaning robot and a total number of days included in the pre-set period. Correspondingly, a range of the total areas that can be cleaned in every pre-set period may be equal to a product of an area threshold range corresponding to a battery power threshold range of the cleaning robot and a total number of days included in the pre-set period.

The area threshold corresponding to the battery power threshold of the cleaning robot indicates: when the cleaning robot is fully charged, the maximum area the cleaning robot can clean without recharging, e.g., 100 m². Because the power consumption of the cleaning robot is closely related to the moving mileage, when the cleaning area is the same, the moving mileage of the cleaning robot may be different (based on different moving trajectories), and therefore, the power consumption may be different. In addition, the reduction in the electric power is often not in a positively proportional linear relationship with the moving mileage. Therefore, the area threshold is merely a statistical value based on experience, and is only used for rough comparison and assessment.

As such, through the first condition and the second condition, multiple cleanings can be performed by the cleaning robot in the pre-set period when the electrical power is limited, in which the number of cleanings for the first category of sub-zones, i.e., key zones, is greater than a pre-set number or greater than an upper limit of a pre-set number range, thereby satisfying the user's cleaning needs for the key zones. In some situations, even if the cleaning robot cannot perform cleaning tasks for all of the key zones and non-key zones, at least it may be ensured that priority is given to the cleaning tasks of the key zones, which, to a relatively larger extent, ensures the satisfaction level of the user.

In some embodiments, the total area/total area range that can be cleaned in every pre-set period may be estimated based on the total area/total area range that can be cleaned in the pre-set period that are historically recorded by the cleaning robot. For example, the area/area range of the same work zone that was cleaned in the previous pre-set period, which was recorded by the cleaning robot, may be used as the total area/total area range that can be cleaned in every pre-set period. As another example, an average value of the area/area range that was cleaned in a few previous pre-set periods, which were recorded by the cleaning robot, may be used as the total area/total area range that can be cleaned in every pre-set period.

As such, through the first condition and the second condition, with the historically recorded cleaning areas, multiple cleanings can be performed by the cleaning robot in the pre-set period, in which the number of cleanings of the first category of sub-zones, i.e., key zones, is greater than a pre-set number or greater than an upper limit of a pre-set number range, thereby satisfying the user's cleaning needs for the key zones.

In some embodiments, a total cleaning time/a total cleaning time range set by the user may be obtained, and an estimation may be made for a product of the total cleaning time/cleaning time range and a moving velocity of the cleaning robot (typically represented by an average moving velocity or a moving velocity under a main work mode). The product may be estimated as a total area/a total area range that can be cleaned in every pre-set period.

As such, through the first condition and the second condition, multiple cleanings are realized by the cleaning robot in the pre-set period under a limited cleaning time, in which the number of cleanings for the first category of sub-zones, i.e., key zones, is greater than a pre-set number or is greater than an upper limit of a pre-set number range, thereby satisfying the user's cleaning needs for the key zones.

On the basis of the second embodiment, further limiting the weekly cleaning constraining condition to also include a third condition yields a third embodiment.

### Third Embodiment

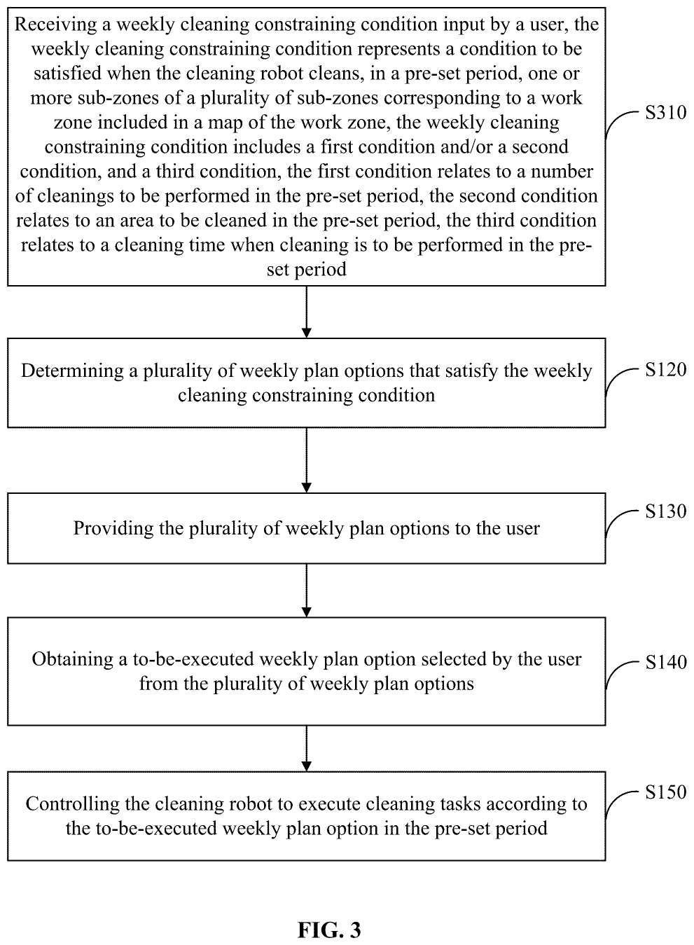

Referring to FIG. 3, the control method of this illustrative embodiment may also include the following steps:

Step S310, receiving the weekly cleaning constraining condition input by the user, where the weekly cleaning constraining condition represents a condition to be satisfied when the cleaning robot cleans, in a pre-set period, one or more sub-zones of a plurality of sub-zones corresponding to a work zone included in a map of the work zone. The weekly cleaning restraining condition includes a first condition and/or a second condition, and a third condition. The first condition relates to a number of cleanings to be performed in the pre-set period, the second condition relates to an area to be cleaned (or a cleaning area) in the pre-set period, and the third condition relates to a cleaning time when cleaning is to be executed in the pre-set period.

In this embodiment, the weekly cleaning restraining condition may include a first condition and/or a second condition and a cleaning time limiting condition (the third condition). Here, the third condition may be configured to specify a cleaning time. It should be understood that, the weekly cleaning restraining condition may include any combination of the first condition and/or the second condition and the third condition, for example, one first condition and one third condition; one first condition and multiple third conditions; multiple first conditions and one third condition; multiple first conditions and multiple third conditions; one second condition and one third condition; one second condition and multiple third conditions; multiple second conditions and one third condition; multiple second conditions and multiple third conditions; one first condition, one second condition and one third condition, etc. Illustratively, if the first condition specifies a first pre-set number, the second condition specifies a first area to be cleaned, and the third condition specifies a first cleaning time, then the three conditions together can form a weekly cleaning restraining condition.

Descriptions relating to the first condition and the second condition can refer to the descriptions of the second embodiment, which are not repeated.

In some embodiments, illustratively, the third condition may be configured to specify at least one of the following items: a number of interval days between cleanings for the same category of sub-zones or the same sub-zone (including various situations such as a minimum number of interval days, a maximum number of interval days, etc.), a relative length and an absolute length of a cleaning time on a pre-set day of the pre-set period (including various scenarios such as: the cleaning time in the pre-set period for a non-key zone being shorter than the cleaning time for a key zone, a cleaning time of a certain sub-zone in the pre-set period or on a number of days being the shortest as compared to the cleaning time of other sub-zones, a cleaning time of a certain sub-zone or a certain category of sub-zones in the pre-set period or on a certain day being not more than or not less than a certain number of minutes/hours), and a do-not-disturb time segment in the pre-set period.

In this embodiment, illustratively, the weekly cleaning restraining condition may also include the third condition configured to specify a number of interval days between cleanings for a corresponding category of sub-zones. Illustratively, the third condition may specify a number of interval days between cleanings for a same sub-zone of the second category of sub-zones. Illustratively, it is presumed that the pre-set period is from Monday to Sunday, the first category of sub-zones set by the user is room R11, the second category of sub-zones are rooms R12, R13, and R14, the first condition set by the user specifies: the first category of sub-zones (i.e., room R11) are cleaned 7 times in every pre-set period and cleaned 1 time on each day, each sub-zone of the second category of sub-zones (i.e., rooms R12, R13, and R14) is each cleaned 1 time in every pre-set period. The second condition set by the user specifies: a total cleaning area to be completed on each day of the pre-set period, i.e., the second area, does not exceed 100 m². The third condition set by the user specifies that the number of interval days for cleaning a same sub-zone of the second category of sub-zones is greater than or equal to 2 (e.g., the situation of being separated by 2 days between Wednesday and Monday of a same week). In other words, rooms R12, R13, and R14 that belong to the same second category of sub-zones cannot be cleaned on the same day, and cannot be cleaned on adjacent days. In addition, from the movement of the cleaning robot, it can be known that: the cleaning area of room R11 is 50 m², the cleaning area of room R12 is 40 m², the cleaning area of room R13 is 30 m², and the cleaning area of room R14 is 20 m². Then, based on the user settings and the actual situation of the work zone, the processing unit of the cleaning robot or the user device may filter out weekly plan options that satisfy the above conditions through a method that tries a large number of conditions or an exhaustive search method. Illustratively, the following weekly plan option may be determined:

Weekly Plan Option 5

| | Monday | Tuesday | Wednesday | Thursday | Friday | Saturday | Sunday |
|---|---|---|---|---|---|---|---|
| Zones | R11 | R11 + R12 | R11 | R11 + R13 | R11 | R11 + R14 | R11 |
| Number | 1 time | 1 time for | 1 time | 1 time for | 1 time | 1 time for | 1 time |
| of | | each | | each | | each | |
| Cleanings | | zone | | zone | | zone | |
| Area | 50 m² | 90 m² | 50 m² | 80 m² | 50 m² | 70 m² | 50m2 |

As can be seen from the above weekly plan option 5, the rooms R12, R13, and R14 that belong to the second category of sub-zones are arranged to be cleaned on Tuesday, Thursday, and Saturday, thereby satisfying the requirement of the third condition. The above weekly plan option is only illustrative. In some embodiments, through computation and filtering, the processing unit may provide other weekly plan options to the user. The other weekly plan options may include, for example, when the first condition and the second condition are satisfied, rooms R12, R13, and R14 that belong to the second category of sub-zones are respectively arranged on Monday, Wednesday, Friday, or are respectively arranged on Wednesday, Friday, Sunday, or are respectively arranged on Monday, Thursday, Sunday to execute the cleaning tasks, etc., which also satisfy the requirement of the third condition. As such, the above option satisfies the above-described user settings and the actual situation of the work zone, and hence, can be a weekly plan option to be provided to the user for the user to select.

Continuing with the above example, it is presumed that the first condition and the third condition are not changed, and the user changes the second condition, such that the changed second condition specifies: (1) a sum of cleaning areas to be completed on each day of the pre-set period, i.e., the second area, does not exceed 100 m²; (2) the cleaning area to be completed on each day of Monday, Wednesday, Friday, Sunday does not exceed 60 m². After the processing unit performs computation and filtering for various scenarios, the following weekly plan option may be determined:

Weekly Plan Option 6

| | Monday | Tuesday | Wednesday | Thursday | Friday | Saturday | Sunday |
|---|---|---|---|---|---|---|---|
| Zones | R11 | R11 + R14 | R11 | R11 + R13 | R11 | R11 + R12 | R11 |
| Number | 1 time | 1 time for | 1 time | 1 time for | 1 time | 1 time for | 1 time |
| of | | each | | each | | each | |
| Cleanings | | zone | | zone | | zone | |
| Area | 50 m² | 70 m² | 50 m² | 80 m² | 50 m² | 90 m² | 50m2 |

In this embodiment, the weekly cleaning restraining condition may also include the third condition configured to specify that a cleaning time on a pre-set day of the pre-set period is the shortest. For example, the third condition may specify: a cleaning time on each of Saturday and Sunday is the shortest (i.e., the cleaning time or the cleaning area for Saturday, Sunday is shorter or smaller than that on any day from Monday to Friday). As such, it may be determined that the above weekly plan options 1, 2, and 3 are weekly plan options that satisfy the third condition, and the above weekly plan options 4, 5, and 6 and other options that do not satisfy any of the above conditions are excluded, thereby realizing a smart function of automatically providing to the user weekly plan options that satisfy the subjective requirements of the user.

In this embodiment, the weekly cleaning restraining condition may also include the third condition configured to specify a do-not-disturb time segment in the pre-set period. For example, the third condition may specify: the do-not-disturb time segment in the pre-set period is a specific time segment on Saturday and Sunday. Referring to FIG. 2d, the do-not-disturb time segment is set as 12:00-14:00.

Step S120, determining weekly plan options that satisfy the weekly cleaning restraining condition.

Step S130, providing the weekly plan options to the user.

Step S140, obtaining a to-be-executed weekly plan option selected by the user from the weekly plan options.

Step S150, controlling the cleaning robot to execute cleaning tasks in the pre-set period according to the to-be-executed weekly plan option.

Descriptions of steps S120-S150 can refer to the above descriptions of the first embodiment and the second embodiment, which are not repeated.

Therefore, according to this embodiment, the first condition and/or the second condition and the third condition input by the user based on the user's preferences and cleaning needs are obtained. After the processing unit performs computation, a plurality of weekly plan options that satisfy the first condition and/or the second condition and the third condition that are associated with user settings and the actual situation of the work zone are provided to the user. A to-be-executed weekly plan option selected by the user from the plurality of weekly plan options is obtained. Finally, the cleaning robot executes cleaning tasks in the pre-set period according to the to-be-executed weekly plan option. As such, as compared to traditional, fixed and rigid cleaning plans, in which the user directly inputs when and which zones the cleaning tasks are to be performed, in the present embodiment, merely a few questions are provided to the user about the life habits and preferences of the user. Based on answers provided by the user, in the present embodiment, computation is performed and weekly plan options that satisfy the first condition and/or the second condition and the third condition that are associated with user settings and the actual situation of the work zone are automatically provided to the user. Accordingly, the present embodiment enables the cleaning robot to perform cleaning tasks in a more intelligent and personalized manner, thereby enhancing the user experience.

On the basis of the third embodiment, further limiting that the received weekly cleaning constraining condition to also include a fourth condition yields a fourth embodiment.

### Fourth Embodiment

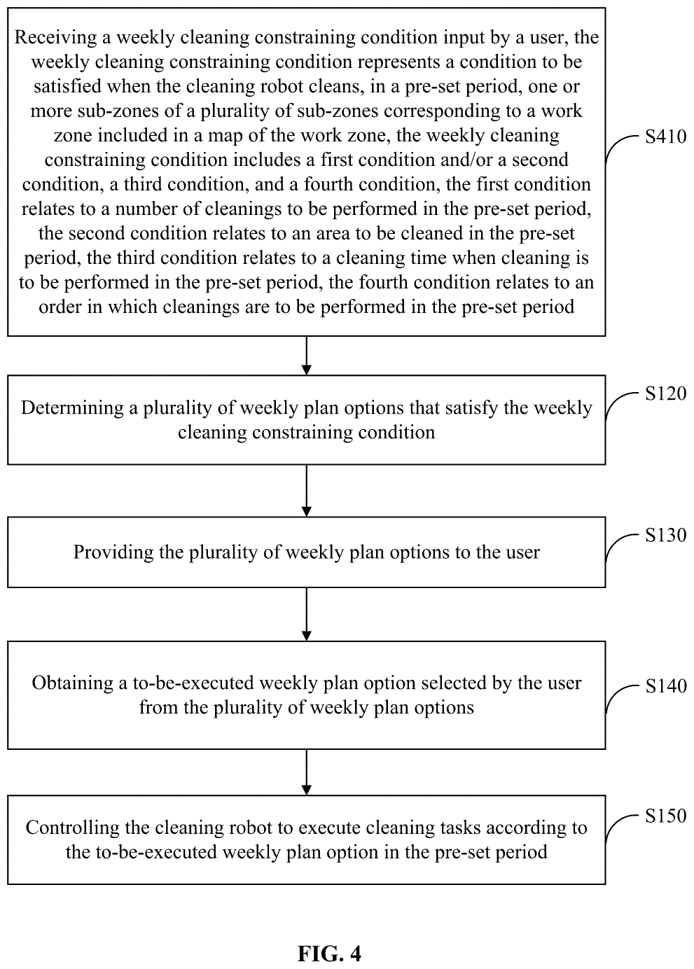

Referring to FIG. 4, the control method of this illustrative embodiment may include the following steps:

Step S410, receiving the weekly cleaning constraining condition input by the user, where the weekly cleaning constraining condition represents a condition to be satisfied when the cleaning robot cleans, in a pre-set period, one or more sub-zones of a plurality of sub-zones corresponding to a work zone included in a map of the work zone. The weekly cleaning constraining condition includes a first condition and/or a second condition, a third condition and a fourth condition. The first condition relates to a number of cleanings to be performed in the pre-set period, the second condition relates to an area to be cleaned (or a cleaning area) in the pre-set period, the third condition relates to a cleaning time when cleaning is to be performed in the pre-set period, and the fourth condition relates to a cleaning order in which cleanings are to be performed in the pre-set period.

In this embodiment, the weekly cleaning constraining condition may include the first condition and/or the second condition, the third condition and a limiting condition based on the cleaning order (the fourth condition). Here, the fourth condition may be configured to specify a cleaning order (e.g., a cleaning order of a plurality of different sub-zones, a cleaning order of a plurality of sub-zones belonging to different categories). It should be understood that the weekly cleaning constraining condition may be any suitable combination of the first condition and/or the second condition, the third condition and the fourth condition, for example, one/multiple first conditions and one/multiple fourth conditions; one/multiple second conditions and one/multiple fourth conditions; one/multiple third conditions and one/multiple fourth conditions; one/multiple first conditions, one/multiple second conditions and one/multiple fourth conditions; one/multiple first conditions, one/multiple third conditions and one/multiple fourth conditions; one/multiple second conditions, one/multiple third conditions and one/multiple fourth conditions; one/multiple first conditions, one/multiple second conditions, one/multiple third conditions and one/multiple fourth conditions, etc. Illustratively, if the first condition specifies a first pre-set number of cleanings, the second condition specifies a first cleaning area, the third condition specifies a first cleaning time, and the fourth condition specifies a first cleaning order, then the four conditions may together form a weekly cleaning restraining condition.

Descriptions of the first condition, the second condition and the third condition can refer to the descriptions of the second embodiment and the third embodiment, which are not repeated.

In some embodiments, the fourth condition may be configured to specify conditions relating to the cleaning order, such as a cleaning order for cleaning a plurality of sub-zones or a cleaning order for cleaning a plurality of sub-zones of a same category and/or a cleaning order for cleaning a plurality of sub-zones on a same day. Illustratively, for example, the fourth condition may be configured to specify a cleaning order based on an area (from large to small) for cleaning a plurality of sub-zones of the same category, or to specify a cleaning order based on a cleaning time (from long to short) for cleaning the plurality of sub-zones of the same category, or to specify a cleaning order based on a serial number (from small to large or from large to small) for cleaning the plurality of sub-zones, etc.

Continuing with the examples of the second embodiment and the third embodiment, it is presumed that the fourth condition set by the user specifies that sub-zones of the second category (i.e., rooms R12, R13, R14 in the above-described embodiments, here, the cleaning area of room R12 is 40 m², the cleaning area of room R13 is 30 m², the cleaning area of room R14 is 20 m²) are to be cleaned based on an order of large cleaning areas to small cleaning areas. Based on the user settings and the actual situation of the work zone, the processing unit of the cleaning robot or the user device may filter out weekly plan options that satisfy the above conditions through a method that tries a large number of conditions or an exhaustive search method. Illustratively, it may be determined that weekly plan options 1, 2, and 5 are the weekly plan options that satisfy the fourth condition, and weekly plan options 3, 4, and 6 and other options that do not satisfy any of the above conditions are excluded, thereby realizing a smart function of automatically providing to the user weekly plan options that satisfy the subjective requirements of the user.

Step S120, determining weekly plan options that satisfy the weekly cleaning restraining condition.

Step S130, providing the weekly plan options to the user.

Step S140, obtaining a to-be-executed weekly plan option selected by the user from the weekly plan options.

Step S150, controlling the cleaning robot to execute cleaning tasks in the pre-set period according to the to-be-executed weekly plan option.

Descriptions of steps S120-S150 can refer to the descriptions of the first embodiment, which are not repeated.

Therefore, according to this embodiment, the first condition and/or the second condition, the third condition and the fourth condition that are input based on user's preferences and cleaning need may be obtained. Then after the processing unit performs computation, a plurality of weekly plan options that satisfy the first condition and/or the second condition, the third condition and the fourth condition that are associated with the user settings and the actual situation of the work zone may be provided to the user, and a to-be-executed weekly plan option selected by the user from the plurality of weekly plan options may be obtained. Finally, the cleaning robot may execute cleaning tasks in the pre-set period according to the to-be-executed weekly plan option. As such, as compared to traditional, fixed and rigid cleaning plans, in which the user directly inputs when and which zones the cleaning tasks are to be performed, in the present embodiment, merely a few questions are provided to the user about the life habits and preferences of the user. Based on answers provided by the user, in the present embodiment, computation is performed and weekly plan options that satisfy the first condition and/or the second condition, the third condition and the fourth condition that are associated with the user settings and the actual situation of the work zone are automatically provided to the user. Accordingly, the present embodiment enables the cleaning robot to perform cleaning tasks in a more intelligent and personalized manner, thereby enhancing the user experience.

On the basis of the fourth embodiment, further limiting the received weekly cleaning restraining condition to also include a fifth condition yields a fifth embodiment.

### Fifth Embodiment

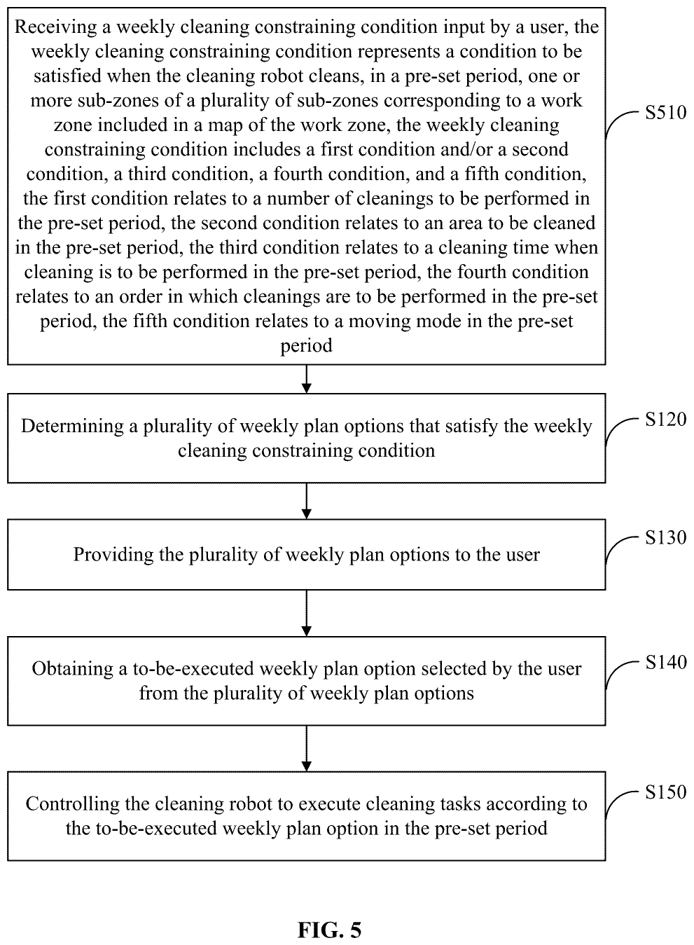

Referring to FIG. 5, the control method of the present illustrative embodiment may include the following steps:

Step S510, receiving a weekly cleaning constraining condition input by a user. The weekly cleaning constraining condition represents a condition to be satisfied when the cleaning robot cleans, in a pre-set period, one or more sub-zones of a plurality of sub-zones corresponding to a work zone included in a map of the work zone. The weekly cleaning restraining condition may include a first condition and/or a second condition, a third condition, a fourth condition and a fifth condition. The first condition relates to a number of cleanings to be performed in the pre-set period. The second condition relates to an area to be cleaned (or a cleaning area) in the pre-set period. The third condition relates to a cleaning time when cleaning is to be performed in the pre-set period. The fourth condition relates to a cleaning order in which cleanings are performed in the pre-set period. The fifth condition relates to a moving mode in the pre-set period.

In this embodiment, the weekly cleaning restraining condition may include a first condition and/or a second condition, a third condition, a fourth condition and a limiting condition based on the moving mode (the fifth condition). Here, the fifth condition may be configured to specify the moving mode. It should be understood that the weekly cleaning restraining condition may be any suitable combination of the first condition and/or the second condition, the third condition, the fourth condition, and the fifth condition, for example, one/multiple first conditions and one/multiple fifth conditions; one/multiple second conditions and one/multiple fifth conditions; one/multiple third conditions and one/multiple fifth conditions; one/multiple fourth conditions and one/multiple fifth conditions; one/multiple first conditions, one/multiple second conditions and one/multiple fifth conditions; one/multiple first conditions, one/multiple third conditions and one/multiple fifth conditions; one/multiple first conditions, one/multiple fourth conditions and one/multiple fifth conditions; one/multiple second conditions, one/multiple third conditions and one/multiple fifth conditions; one/multiple second conditions, one/multiple fourth conditions and one/multiple fifth conditions; one/multiple third conditions, one/multiple fourth conditions and one/multiple fifth conditions; one/multiple first condition, one/multiple second conditions, one/multiple third conditions and one/multiple fifth conditions; one/multiple first conditions, one/multiple second conditions, one/multiple third conditions and one/multiple fifth conditions; one/multiple first conditions, one/multiple second conditions, one/multiple fourth conditions and one/multiple fifth conditions; one/multiple second conditions, one/multiple third conditions, one/multiple fourth conditions and one/multiple fifth conditions; one/multiple first conditions, one/multiple second conditions, one/multiple third conditions, one/multiple fourth conditions and one/multiple fifth conditions, etc. Illustratively, if the first condition specifies a first pre-set number of cleanings, the second condition specifies a first cleaning area, the third condition specifies a first cleaning time, the fourth condition specifies a first cleaning order, and the fifth condition specifies a first moving mode, then these five conditions together may form a weekly cleaning restraining condition.

Descriptions of the first condition, the second condition, the third condition, and the fourth condition can refer to the descriptions of the second embodiment to the fourth embodiment, which are not repeated.

In some embodiments, the moving mode may include at least one of a cornrow covering mode, an edge following mode, a predicament escaping mode, a navigation mode, or a return-to-recharge mode (i.e., returning to a docking station to recharge); here, the return-to-recharge mode may include a first return-to-recharge mode, a second return-to-recharge mode, and a third return-to-recharge mode. In the first return-to-recharge mode (also referred to as an active return-to-recharge mode), the cleaning robot may perform return-to-recharge after having moved past a pre-set time segment or after having moved for a pre-set amount of moving time. In the second return-to-recharge mode (also referred to as a feedback return-to-recharge mode), the cleaning robot may perform return-to-recharge according to a remaining electrical power (e.g., when the remaining electrical power is less than a pre-set electrical power threshold). In the third return-to-recharge mode, the cleaning robot may perform return-to-recharge after having moved past a pre-set time segment or after having moved for a pre-set amount of moving time, or after a pre-set area has been cleaned, and after completing recharging, the cleaning robot may continue to perform cleaning until the electrical power is less than the pre-set electrical power threshold, and then the cleaning robot may again perform return-to-recharge, and may not again execute cleaning tasks after the recharging is completed.

In this embodiment, the weekly cleaning restraining condition may also include a fifth condition configured to specify a moving mode in which the cleaning robot operates. Therefore, the fifth condition also limits the moving mode of the cleaning robot.

Illustratively, the fifth condition set by the user may specify the following third return-to-recharge mode: the cleaning robot may first move for one hour (the cleaning robot may clean an area of 30 m² during the 1-hour movement), and then return to the docking station to recharge. After being fully charged, the cleaning robot may continue moving until the electrical power is less than a pre-set electrical power threshold (during this period the cleaning robot may clean an area of 100 m²), and then again return to the docking station to recharge. After being fully charged, the cleaning robot may not again move out of the docking station to clean the floor. Therefore, because the cleaning robot first moves for 1 hour, the cleaning area in this 1 hour is 30 m², and the cleaning area is 100 m² during a period from finishing the first return-to-recharge processing to a moment when the electrical power is lower than the pre-set electrical power value. Therefore, the cleaning area is 130 m² when the cleaning robot moves for one round according to the specified third return-to-recharge mode. As such, by specifying the third return-to-recharge mode, the cleaning area of the cleaning robot on a day may be increased.

In some embodiments, the fifth condition may be configured to specify at least one of the following moving modes. The moving modes may include at least one of: a cornrow covering mode, an edge following mode, a predicament escaping mode, a navigation mode, a return-to-recharge mode. In the cornrow covering mode, the cleaning robot executes cleaning tasks in the work zone in a form of alternating “first long edge—first short edge—second long edge—second short edge.” Here the first long edge and the second long edge are parallel. When the cleaning robot encounters an obstacle when moving along the first long edge or the second long edge, the cleaning robot turns to the direction of the first short edge or the second short edge. In some situations, the direction of the first short edge and the direction of the first long edge are roughly or approximately perpendicular. In some situations, the direction of the first short edge is roughly parallel with an adjacent obstacle. Because this floor covering mode is similar to the Chinese character “Gong” (meaning bow), thus, it is often referred to as the cornrow covering mode (simply referred to as a cornrow mode). In the edge following mode, the cleaning robot constantly detects an obstacle located on a side through a proximity sensor mounted to its side, and maintains a roughly constant distance to the side obstacle or maintains a pre-set range of distance to the side obstacle. The edge following mode is a mode in which the cleaning robot moves along the edge of the obstacle in this manner. The edge following mode is typically used to clean the edge of the obstacle (e.g., a wall or furniture). The predicament escaping mode is a manner in which the cleaning robot escapes a predicament when the cleaning robot encounters the predicament (e.g., a narrow space with a narrow size that can block/hinder the movement of the cleaning robot, or an environment similar to a meeting room or a space surrounding a dining table where there are lots of table legs and chair legs). The predicament escaping mode may be a mode, in which the cleaning robot escapes a predicament by taking a manner of first retreating then turning or swinging left and right while retreating. The navigation mode refers to a non-stop manner in which the cleaning robot moves from a certain point in the work zone to a certain target point in the work zone. In the navigation mode, the cleaning robot may need to circumvent a known obstacle during the movement, and may move to the target point in a path that is as short as possible. The return-to-recharge mode is a moving mode in which the cleaning robot returns back to the docking station when the cleaning robot needs to be charged.

In some embodiments, the fifth condition is configured to specify different moving modes. The fifth condition may be used in combination with other conditions. Illustratively, the second condition configured to specify a cleaning area may be used in combination with the moving mode of the fifth condition. For example, a limitation may be set that within a 100 m² cleaning area, a ratio between a moving area in the cornrow covering mode and a moving area in the edge following mode is 10:1; or a limitation may be set that the first 30 m² of area in the first movement on each day or on a certain day is covered under either the cornrow covering mode or the edge following mode. Illustratively, the cleaning time in which cleaning is to be executed in the pre-set period, as specified in the third condition, may be used in combination with the moving mode of the fifth condition. For example, a limitation may be set that in the first 10 minutes of the first movement on each day or on a certain day, the cleaning robot moves in either the cornrow covering mode or the edge following mode. Here, other possible use scenarios are not exhaustively listed. Due to the limitation of space, this embodiment does not list all of the weekly plan options that satisfy these conditions.

Step S120, determining weekly plan options that satisfy the weekly cleaning restraining condition.

Step S130, providing the weekly plan options to the user.

Step S140, obtaining a to-be-executed weekly plan option selected by the user from the weekly plan options.

Step S150, controlling the cleaning robot to execute cleaning tasks in the pre-set period according to the to-be-executed cleaning option.

Descriptions of steps S120-S150 can refer to the descriptions of the first and second embodiments, which are not repeated.

Therefore, according to this embodiment, the first condition and/or the second condition, the third condition, the fourth condition and the fifth condition that are input based on user's preferences and cleaning need may be obtained. Then after the processing unit performs computation, a plurality of weekly plan options that satisfy the first condition and/or the second condition, the third condition, the fourth condition and the fifth condition that are associated with the user settings and the actual situation of the work zone may be provided to the user, and a to-be-executed weekly plan option selected by the user from the plurality of weekly plan options may be obtained. Finally, the cleaning robot may execute cleaning tasks in the pre-set period according to the to-be-executed weekly plan option. As such, as compared to traditional, fixed and rigid cleaning plans, in which the user directly inputs when and which zones the cleaning tasks are to be performed, in the present embodiment, merely a few questions are provided to the user about the life habits and preferences of the user. Based on answers provided by the user, in the present embodiment, computation is performed and weekly plan options that satisfy the first condition and/or the second condition, the third condition, the fourth condition and the fifth condition that are associated with the user settings and the actual situation of the work zone are automatically provided to the user. Accordingly, the present embodiment enables the cleaning robot to perform cleaning tasks in a more intelligent and personalized manner, thereby enhancing the user experience.

### Sixth Embodiment

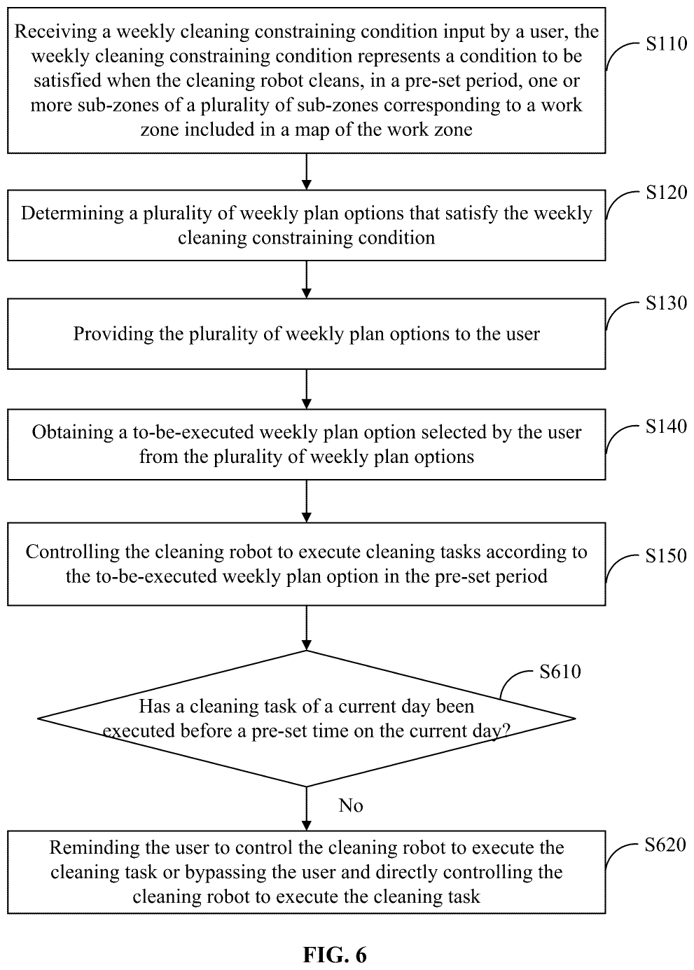

Suitable adjustment on the basis of the first embodiment yields the sixth embodiment. Referring to FIG. 6, the control method of the sixth embodiment differs from the control method of the first embodiment in that, after executing step S150, steps S610 and S620 are executed. In other words, the control method may include steps S110-S150 and Steps S610 and S620. Descriptions of steps S110-S150 can refer to the descriptions of the first embodiment.

Step S610, on a current day of the pre-set period in which a cleaning task is to be executed, determining whether the cleaning robot has already performed the cleaning task before a pre-set time on the current day. When the determination is “No,” step S620 may be executed. When the determination is “Yes,” the processing is terminated.

Step S620, reminding the user to control the cleaning robot to execute the cleaning tasks, or bypassing the user and directly controlling the cleaning robot to execute the cleaning tasks.

Sometimes the user may select to start up the cleaning robot by himself/herself. According to the to-be-executed weekly plan option selected by the user, there is often sufficient time to perform the cleaning tasks. If the operation is started too late on each day, the cleaning tasks may not be finished on that day. Therefore, in this embodiment, the processing unit may pre-calculate the latest start-up time on the current day based on various conditions set by the user. If the cleaning robot does not execute the cleaning tasks of the current day, a reminder may be provided to the user to remind the user that the cleaning tasks of the current day have not been executed, so as to urge the user to control the cleaning robot to execute the cleaning tasks. Furthermore, another reminder time may be added to the latest starting time, such that after the user sees the reminder about the cleaning robot, the user still has time to start up the cleaning robot to execute the cleaning tasks. Moreover, if the user still has not started up the cleaning robot to execute the cleaning tasks at the latest start-up time, the processing unit of the cleaning robot may bypass the user and directly control the cleaning robot to execute the cleaning tasks of the current day. In some embodiments, reminders may not be provided to the user, and the processing unit of the cleaning robot may automatically bypass the user and directly control the cleaning robot to execute the cleaning tasks of the current day. As such, a situation may be avoided where the weekly cleaning tasks are not finished by the cleaning robot due to the negligence of the user.

### Seventh Embodiment

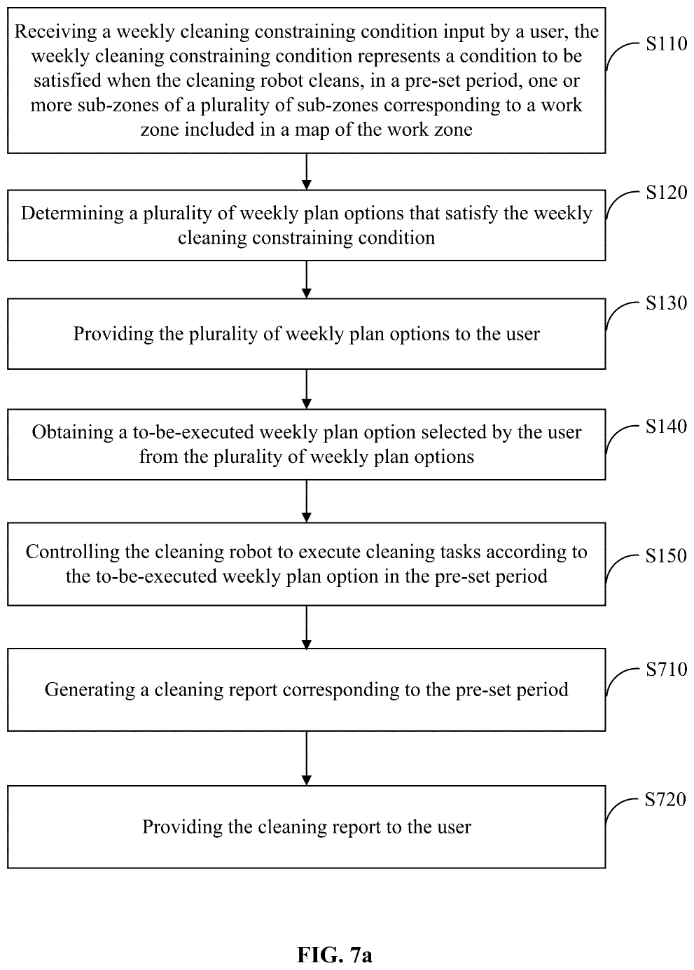

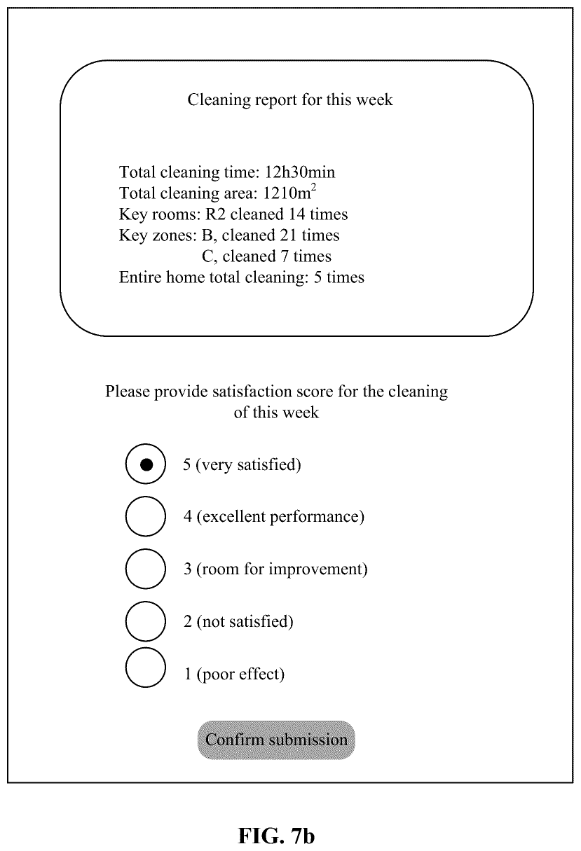

Suitable adjustment on the basis of the first embodiment yields the seventh embodiment. Referring to FIG. 7a, the control method of the seventh embodiment differs from the control method of the first embodiment in that, after executing step S150, steps S710 and S720 may be further executed. In other words, the control method includes steps S110-S150 and steps S710 and S720. Descriptions of steps S110-S150 can refer to the descriptions of the first embodiment.

Step S710, generating a cleaning report corresponding to the pre-set period.

Step S720, providing the generated cleaning report to the user.

In this embodiment, when the cleaning tasks of the pre-set period are completed, the cleaning report may be generated and provided to the user. The cleaning report of the pre-set period may include at least one of a total cleaning time in the pre-set period, a total cleaning area covered in the pre-set period, a total number of cleanings performed to the corresponding first category of sub-zones, a total number of cleanings performed to the corresponding second category of sub-zones, or a total number of cleanings performed in the work zone of the closed space, etc. Referring to FIG. 7b, the cleaning report for this week may include: a total cleaning time is 12 hours and 30 minutes; a total cleaning area covered is 1210 m²; the number of cleanings for key room R2 is 14; the number of cleanings for key zones B and C are 21 and 7; the total number of cleanings for the entire home is 5.

Through providing the cleaning report to the user, the user is enabled to intuitively learn about the cleaning tasks performed in the present pre-set period.

In some embodiments, the cleaning report may also show items for scoring the satisfaction levels of the cleanings performed in the present pre-set period, such that the user can input scores, which makes it convenient to optimize the weekly plan options based on the user scores.

### Eighth Embodiment

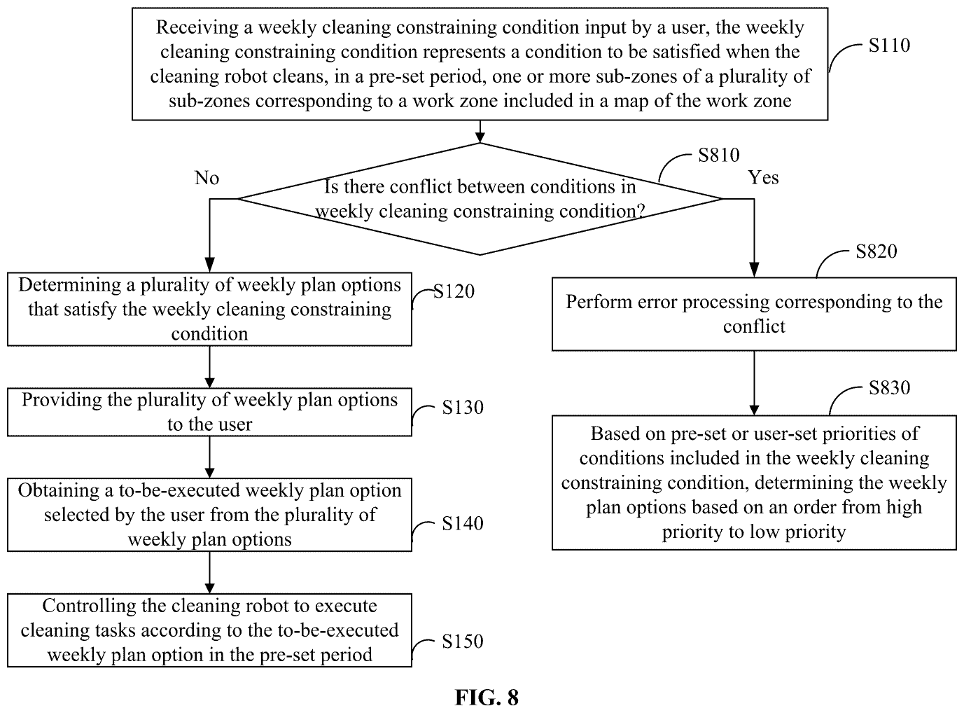

Suitable adjustment on the basis of the first embodiment yields the eighth embodiment. Referring to FIG. 8, the control method of this illustrative embodiment may also include the following steps:

Step S110, receiving a weekly cleaning constraining condition input by the user, where the weekly cleaning constraining condition represents a condition to be satisfied when the cleaning robot cleans, in a pre-set period, one or more sub-zones of a plurality of sub-zones corresponding to a work zone included in a map of the work zone.

Step S820, determining whether conditions included in the weekly cleaning restraining condition conflict each other; when the determination is “Yes,” step S820 may be executed; otherwise, step S120 may be executed.

In this embodiment, considering that there may exist a situation in which multiple weekly cleaning constraining conditions may conflict each other (or at least two conditions may conflict each other), under this situation, it is possible that the conflicting weekly cleaning constraining conditions would not form a weekly plan option. Therefore, when the weekly cleaning constraining condition includes multiple conditions, a determination may be made as to whether these conditions conflict each other (or at least two conditions conflict each other). When it is determined that these conditions do not conflict each other, then steps S120-S150 may be executed sequentially. When it is determined that at least two conditions in these conditions conflict each other, then an error processing may be performed, thereby avoiding the situation in which the cleaning robot still awaits to execute steps S120-S150 when there is a conflict between conditions included in the weekly cleaning constraining condition.

Step S120, determining a plurality of weekly plan options that satisfies the weekly cleaning constraining condition.

Step S130, providing the plurality of weekly plan options to the user.

Step S140, obtaining a to-be-executed weekly plan option selected by the user from the plurality of weekly plan options.

Step S150, controlling the cleaning robot to execute cleaning tasks in the pre-set period according to the to-be-executed weekly plan option.

Descriptions of steps S110-S150 can refer to the descriptions of the first embodiment, which are not repeated.

Step S820, performing error processing corresponding to the conflict. Illustratively, when a conflict occurs, the user may be alerted that a conflict has occurred.

Illustratively, it is presumed that the pre-set period is from Monday to Sunday. The first condition set by the user may specify that on Monday, each of rooms R11, R12, R13, and R14 is to be cleaned 1 time. The second condition set by the user may specify that on each day of the pre-set period, a total cleaning area to be covered, i.e., the second area, does not exceed 100 m². In addition, it can be known from the movement of the cleaning robot: the cleaning area of room R11 is 50 m², the cleaning area of room R12 is 40 m², the cleaning area of room R13 is 30 m², the cleaning area of room R14 is 20 m². The processing unit of the cleaning robot or the user device may determine, through computation, that the first condition conflicts the second condition, and may alert that user that a conflicting event has occurred between the first condition and the second condition.

Step S830, based on pre-set or user-set priorities of conditions included in the weekly cleaning constraining condition, determining the weekly plan options based on an order of high priority to low priority.

In this embodiment, after a conflict has occurred and the error processing has been performed, based on the pre-set or user-set priorities of conditions included in the weekly cleaning constraining condition, the weekly plan options are determined based on an order of high priority to low priority. As such, the weekly plan options may be determined by using one of the conflicting conditions that has a higher priority rather than using a condition having a lower priority. In some embodiments, after the conflict has occurred and the error processing has been performed, the conflict conditions may be re-set, such that non-conflicting parameters are set for the conflicting conditions. Regardless of which processing is used, the issue of being unable to determine the weekly plan options due to conflicting conditions can be resolved.

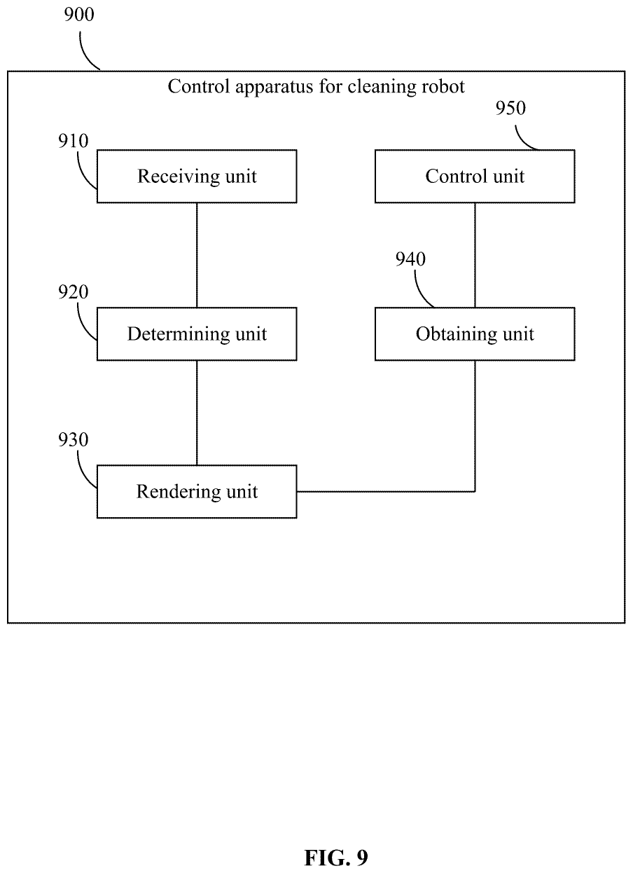

FIG. 9 is a schematic diagram of a control apparatus for a cleaning robot according to an illustrative embodiment. Referring to FIG. 9, the control apparatus 900 may include a receiving unit 910, a determining unit 920, a rendering unit 930, an obtaining unit 940 and a control unit 950. The control apparatus 900 may be implemented in a cleaning robot, a remote controller or user device that may be configured to control the operations of the cleaning robot or provide controlling instructions to the cleaning robot for controlling the operations of the cleaning robot.

The receiving unit 910 may be configured to receive the weekly cleaning constraining condition input by the user. The weekly cleaning constraining condition represents a condition to be satisfied when the cleaning robot cleans, in a pre-set period, one or more sub-zones of a plurality of sub-zones corresponding to a work zone included in a map of the work zone, where the pre-set period is a period that uses day as a unit and includes a pre-set number of days, and where the pre-set number of days is greater than a number of days included in a daily cleaning period, and is smaller than a number of days included in a monthly cleaning period.

The determining unit 920 may be connected with the receiving unit 910, and may be configured to determine weekly plan options the satisfy the weekly cleaning constraining condition. The rendering unit 930 may be connected with the determining unit 920, and may be configured to obtain a to-be-executed weekly plan option selected by the user from the weekly plan options. The control unit 920 may be connected with the obtaining unit 940, and may be configured to control the cleaning robot to execute the cleaning tasks in the pre-set period according to the to-be-executed weekly plan option.

In some embodiments, the weekly cleaning constraining condition may include a first condition and/or a second condition. The first condition relates to a number of cleanings to be performed in the pre-set period. The second condition relates to an area to be cleaned (or a cleaning area) in the pre-set period.

In some embodiments, the weekly cleaning constraining condition may also include a third condition. The third condition relates to a cleaning time in which cleaning is performed in the pre-set period.

In some embodiments, the weekly cleaning constraining condition may also include a fourth condition. The fourth condition relates to an order in which cleanings are to be performed in the pre-set period.

In some embodiments, the weekly cleaning constraining condition may also include a fifth condition. The fifth condition relates to a moving mode in the pre-set period.

In some embodiments, the plurality of sub-zones may be divided into a plurality of categories. The first condition may be configured to specify a total number of cleanings to be performed for a corresponding category of sub-zones in the pre-set period and/or to specify a number of cleanings to be performed on each day of the pre-set period for a corresponding category of sub-zones.

In some embodiments, the plurality of sub-zones may be divided into a plurality of categories. The second condition may be configured to specify a first area that is a sum of areas of sub-zones of all categories where cleaning is needed in the pre-set period and/or a second area that is a sum of areas of sub-zones of all categories where cleaning is needed on a single day. Here, the first area is equal to a sum of a plurality of products, where each product is a product of an area of each sub-zone in each category and a number of cleanings to be performed in the pre-set period corresponding to each sub-zone of each category. The second area is equal to a sum of a plurality of products, where each product is a product of an area of each sub-zone of each category where cleaning is to be performed on a single day and a number of cleanings to be performed on a single day for each corresponding sub-zone of each category.

In some embodiments, the third condition may be configured to specify at least one of the following items: a number of interval days between cleanings for a corresponding category of sub-zones, a cleaning time in a pre-set day of the pre-set period is the shortest, a do-not-disturb time segment in the pre-set period.

In some embodiments, the fourth condition may be configured to specify an order in which multiple sub-zones in a same category are to be cleaned and/or an order in which sub-zones of different categories are to be cleaned on a same day.

In some embodiments, the moving mode may include at least one of a cornrow covering mode, an edge following mode, a predicament escaping mode, a navigation mode, or a return-to-recharge mode. Here, the return-to-recharge mode may include a first return-to-recharge mode, a second return-to-recharge mode, and a third return-to-recharge mode. In the first return-to-recharge mode, the cleaning robot may perform return-to-recharge after having moved past a pre-set time segment or after having moved for a pre-set amount of moving time. In the second return-to-recharge mode, the cleaning robot may perform return-to-recharge when a remaining electrical power is less than a pre-set electrical power threshold. In the third return-to-recharge mode, the cleaning robot may perform return-to-recharge after having moved past a pre-set time segment or after having moved for a pre-set amount of moving time, or after having cleaned a pre-set area, and after recharging is completed, the cleaning robot may continue to perform cleaning until the electrical power is less than the pre-set electrical power threshold, and then the cleaning robot may again perform return-to-recharge and may not execute cleaning tasks again after the recharging is completed.

In some embodiments, the control apparatus 900 may also include: a determining unit (not shown), configured to determine, on the current day in the pre-set period when there are cleaning tasks to be performed, whether the cleaning robot has already executed the cleaning tasks before a pre-set time on the current day; a processing unit (not shown), configured to remind, when it is determined that the cleaning tasks have not been performed before the pre-set time in the current day, the user to control the cleaning robot to execute the cleaning tasks, or to bypass the user and directly control the cleaning robot to execute the cleaning tasks.

In some embodiments, the weekly plan options may change as the weekly cleaning constraining condition changes. Once the to-be-executed weekly plan option changes, the cleaning robot may be controlled to execute new cleaning tasks in the pre-set period according to the changed to-be-executed weekly plan option.

In some embodiments, the control apparatus 900 may also include: a processing unit (not shown), configured to generate a cleaning report corresponding to the pre-set period after completing cleaning tasks in the pre-set period according to the to-be-executed weekly plan option, and provide the cleaning report to the user.

In some embodiments, the control apparatus 900 may also include: an obtaining unit (not shown), configured to obtain sub-zones of various categories set by the user.

In some embodiments, the control apparatus 900 may also include: a processing unit (not shown), configured to, when there is a conflict in conditions included in the weekly cleaning constraining condition, perform an error processing corresponding to the conflict that occurred.

In some embodiments, the determining unit 920 may also be configured to: based on pre-set or user-set priorities of conditions included in the weekly cleaning constraining condition, determine the weekly cleaning options based on an order of high priority to low priority.

Regarding the apparatus in the above embodiment, detailed implementations of various units performing operations have already been described in detail in the embodiments of the related method, which are not repeated.

Various embodiments of the present disclosure have been described. The above descriptions are illustrative, not exhaustive, and are not intended to limit the various disclosed embodiments. Without departing from the scope and spirit of the described various embodiments, many modifications and changes are obvious to a person having ordinary skills in the art. The principle of selection of the terms used in this description, is for best explaining the principles of various embodiments, the technological improvement to the technologies of the actual application or market, or for the purpose of enabling the other persons having ordinary skills in the art to understand the various embodiments described in the present disclosure.

What is claimed is:

1. A control method for a cleaning robot, comprising:
receiving a weekly cleaning constraining condition input by a user, wherein the weekly cleaning constraining condition represents a condition to be satisfied when the cleaning robot cleans, in a pre-set period, one or more sub-zones of a plurality of sub-zones corresponding to a work zone included in a map of the work zone, wherein the pre-set period is an integer multiple of a week;
determining weekly plan options that satisfy the weekly cleaning constraining condition;
providing the weekly plan options to the user;
obtaining a to-be-executed weekly plan option selected by the user from the weekly plan options; and
controlling the cleaning robot to execute a cleaning task in the pre-set period according to the to-be-executed weekly plan option.

2. The control method of claim 1, wherein the weekly cleaning constraining condition includes a first condition and/or a second condition, wherein the first condition relates to a number of cleanings to be performed in the pre-set period, and the second condition relates to an area to be cleaned in the pre-set period.

3. The control method of claim 1, wherein the weekly cleaning constraining condition also includes a third condition, wherein the third condition relates to a cleaning time in which cleaning is to be performed in the pre-set period.

4. The control method of claim 1, wherein the weekly cleaning constraining condition also includes a fourth condition, and wherein the fourth condition relates to a cleaning order in which cleanings are to be performed in the pre-set period.

5. The control method of claim 1 wherein the weekly cleaning constraining condition also includes a fifth condition, and wherein the fifth condition relates to a moving mode in the pre-set period.

6. The control method of claim 2,
wherein the plurality of sub-zones are divided into a plurality of categories, and
wherein the first condition is configured to specify a total number of cleanings to be performed in the pre-set period for a corresponding category of sub-zones and/or to specify a number of cleanings to be performed on each day of the pre-set period for a corresponding category of sub-zones.

7. The control method of claim 2,
wherein the plurality of sub-zones are divided into a plurality of categories,
wherein the second condition is configured to specify a first area that is a sum of areas of sub-zones of all categories in which cleanings are to be performed in the pre-set period and/or a second area that is a sum of areas of sub-zones of all categories in which cleanings are to be performed on a single day,
wherein the first area is equal to a sum of products, wherein each product is a product of an area of each category of sub-zones and a number of cleanings to be performed in the pre-set period corresponding to each category of sub-zones, and
wherein the second area is equal to a sum of products, wherein each product is a product of an area of each category of sub-zones in which cleaning is to be performed on a single day and a number of cleanings to be performed on a single day for each corresponding category of sub-zones.

8. The control method of claim 3, wherein the third condition is configured to specify at least one of the following: a number of interval days between cleanings for a corresponding category of sub-zones, a cleaning time of a pre-set day of the pre-set period being the shortest, or a do-not-disturb time segment in the pre-set period.

9. The control method of claim 4, wherein the fourth condition is configured to specify an order in which a plurality of sub-zones of a same category are to be cleaned and/or an order in which sub-zones of a plurality of categories are to be cleaned on a same day.

10. The control method of claim 5, wherein the moving mode includes at least one of a cornrow covering mode, an edge following mode, a predicament escaping mode, a navigation mode, or a return-to-recharge mode,
wherein the return-to-recharge mode includes a first return-to-recharge mode, a second return-to-recharge mode, and a third return-to-recharge mode,
wherein in the first return-to-recharge mode, the cleaning robot performs return-to-recharge after having moved past a pre-set time segment or after having moved for a pre-set amount of moving time,
wherein in the second return-to-recharge mode, the cleaning robot performs the return-to-recharge when a remaining electrical power is less than a pre-set electrical power threshold,
wherein in the third return-to-recharge mode, the cleaning robot performs return-to-recharge after having moved past a pre-set time segment or after having moved for a pre-set amount of moving time, or after having cleaned a pre-set area, and after completing recharging, the cleaning robot continues to move until the remaining electrical power is less than the pre-set electrical power threshold, and again performs return-to-recharge and does not execute a cleaning task again after recharging is completed.

11. The control method of claim 1, further comprising:
on a current day of the pre-set period in which a cleaning task is to be executed, determining whether the cleaning robot has already executed the cleaning before a pre-set time on the current day,
wherein when the determination is that the cleaning task has not been executed before the pre-set time on the current day, reminding the user to control the cleaning robot to execute the cleaning task, or bypassing the user and directly controlling the cleaning robot to execute the cleaning task.

12. The control method of claim 1, wherein the weekly plan options change as the weekly cleaning constraining condition changes, and the control method further comprises:
in response to a change in the to-be-executed weekly plan option, controlling the cleaning robot to execute new cleaning task according to to-be-executed weekly plan option in the pre-set period.

13. The control method of claim 1, further comprising:
when there is a conflict between at least two conditions included in the weekly cleaning constraining condition, performing an error processing corresponding to the conflict.

14. The control method of claim 1, further comprising:
based on pre-set or user-set priorities of conditions included in the weekly cleaning constraining condition, determining the weekly plan options based on an order from high priority to low priority.

15. A control apparatus for a cleaning robot, comprising:
a receiving unit configured to receive a weekly cleaning constraining condition input by a user, wherein the weekly cleaning constraining condition represents a condition to be satisfied when the cleaning robot cleans, in a pre-set period, one or more sub-zones of a plurality of sub-zones corresponding to a work zone included in a map of the work zone, wherein the pre-set period is an integer multiple of a week,
a determining unit configured to determine weekly plan options that satisfy the weekly cleaning constraining condition;
a rendering unit configured to provide the weekly plan options to the user;
an obtaining unit configured to obtain a to-be-executed weekly plan option selected by the user from the weekly plan options; and
a control unit configured to control the cleaning robot to execute a cleaning task in the pre-set period according to the to-be-executed weekly plan option.

16. The control apparatus of claim 15, wherein the weekly cleaning constraining condition comprises one or more of the following conditions:
a first condition configured to specify a number of cleanings to be performed in the pre-set period;
a second condition configured to specify an area to be cleaned in the pre-set period;
a third condition configured to specify a cleaning time in which cleaning is to be performed in the pre-set period;
a fourth condition configured to specify a cleaning order in which cleanings are to be performed in the pre-set period; and
a fifth condition configured to specify a moving mode in the pre-set period.

17. The control apparatus of claim 15,
wherein the plurality of sub-zones are divided into a plurality of categories,
wherein the first condition is configured to specify a total number of cleanings to be performed in the pre-set period for a corresponding category of sub-zones and/or to specify a number of cleanings to be performed on each day of the pre-set period for a corresponding category of sub-zones,
wherein the second condition is configured to specify a first area that is a sum of areas of sub-zones of all categories in which cleanings are to be performed in the pre-set period and/or a second area that is a sum of areas of sub-zones of all categories in which cleanings are to be performed on a single day,
wherein the first area is equal to a sum of products, wherein each product is a product of an area of each category of sub-zones and a number of cleanings to be performed in the pre-set period corresponding to each category of sub-zones,
wherein the second area is equal to a sum of products, wherein each product is a product of an area of each category of sub-zones in which cleaning is to be performed on a single day and a number of cleanings to be performed on a single day for each corresponding category of sub-zones,
wherein the third condition is configured to specify at least one of the following: a number of interval days between cleanings for a corresponding category of sub-zones, a cleaning time of a pre-set day of the pre-set period being the shortest, or a do-not-disturb time segment in the pre-set period, and
wherein the fourth condition is configured to specify an order in which a plurality of sub-zones of a same category are to be cleaned and/or an order in which sub-zones of a plurality of categories are to be cleaned on a same day.

18. A non-transitory computer-readable storage medium storing instructions, which when executed by a processor, cause the processor to perform a control method for a cleaning robot, the control method comprising:
receiving a weekly cleaning constraining condition input by a user, wherein the weekly cleaning constraining condition represents a condition to be satisfied when the cleaning robot cleans, in a pre-set period, one or more sub-zones of a plurality of sub-zones corresponding to a work zone included in a map of the work zone, wherein the pre-set period is an integer multiple of a week;
determining weekly plan options that satisfy the weekly cleaning constraining condition;
providing the weekly plan options to the user;
obtaining a to-be-executed weekly plan option selected by the user from the weekly plan options; and
controlling the cleaning robot to execute a cleaning task in the pre-set period according to the to-be-executed weekly plan option.

19. The non-transitory computer-readable storage medium of claim 18, wherein the weekly cleaning constraining condition comprises one or more of the following conditions:
a first condition configured to specify a number of cleanings to be performed in the pre-set period;
a second condition configured to specify an area to be cleaned in the pre-set period;
a third condition configured to specify a cleaning time in which cleaning is to be performed in the pre-set period;
a fourth condition configured to specify a cleaning order in which cleanings are to be performed in the pre-set period; and
a fifth condition configured to specify a moving mode in the pre-set period.

20. The non-transitory computer-readable storage medium of claim 18,
wherein the plurality of sub-zones are divided into a plurality of categories,
wherein the first condition is configured to specify a total number of cleanings to be performed in the pre-set period for a corresponding category of sub-zones and/or to specify a number of cleanings to be performed on each day of the pre-set period for a corresponding category of sub-zones,
wherein the second condition is configured to specify a first area that is a sum of areas of sub-zones of all categories in which cleanings are to be performed in the pre-set period and/or a second area that is a sum of areas of sub-zones of all categories in which cleanings are to be performed on a single day,
wherein the first area is equal to a sum of products, wherein each product is a product of an area of each category of sub-zones and a number of cleanings to be performed in the pre-set period corresponding to each category of sub-zones,
wherein the second area is equal to a sum of products, wherein each product is a product of an area of each category of sub-zones in which cleaning is to be performed on a single day and a number of cleanings to be performed on a single day for each corresponding category of sub-zones,
wherein the third condition is configured to specify at least one of the following: a number of interval days between cleanings for a corresponding category of sub-zones, a cleaning time of a pre-set day of the pre-set period being the shortest, or a do-not-disturb time segment in the pre-set period, and
wherein the fourth condition is configured to specify an order in which a plurality of sub-zones of a same category are to be cleaned and/or an order in which sub-zones of a plurality of categories are to be cleaned on a same day.
